(19) United States
(12) Patent Application Publication
(10) Pub. No.: US 2026/0025382 A1
(43) Pub. Date: Jan. 22, 2026

(54) ACCESS CONTROL FOR SHARED RESOURCES

(71) Applicant: MELLANOX TECHNOLOGIES, LTD., Yokneam (IL)

(72) Inventors: Akhil Kadway, Fremont, CA (US); Prabhu Avinashi Sundaram, Fremont, CA (US)

(21) Appl. No.: 18/778,392

(22) Filed: Jul. 19, 2024

(51) Int. Cl. H04L 9/40

(52) U.S. Cl. CPC H04L 63/102

(57) ABSTRACT

Approaches presented herein provide for access control management for shared resources. A request to perform an operation using one or more resources can be analyzed to extract a set of request data, where at least a portion of the request data can be extracted from the request payload. The request data can be compared against an authorization tree for a user, which can include various classes of rules associated with the user role. The actual endpoint for the request can be determined, which may be different from the endpoint otherwise specified for the request, and the appropriate permissions and action determined from the authorization tree. The data to be included in a response can be analyzed using the response tree as well to ensure that no data is included that is otherwise restricted according to the relevant permissions.

### TECHNICAL FIELD

This disclosure relates to the management of access to shared resources, and in particular to frameworks that can be used to manage access control for resources such as may correspond to Restful API endpoints.

### BACKGROUND

In various computing environments-such as data centers or cloud-based resource environments-there is a need to manage access to shared and/or dedicated resources. This can involve not only determining which requests (as may be associated with specific accounts) should be granted access to certain resources, but also ensuring that the proper type of access is granted for the individual requests. There are a variety of existing access control algorithms used for such purposes, but many of these schemes focus on the address or endpoint specified by the request. Other access control schemes may consider other types of information as well, but these schemes primarily perform a strict 1:1 match between rules and requests. Such schemes can be cumbersome to implement and manage, particularly at scale for large numbers of requests and/or numbers of resources.

### BRIEF DESCRIPTION OF THE DRAWINGS

Various embodiments in accordance with the present disclosure will be described with reference to the drawings, in which:

FIG. 1 illustrates an example network architecture allowing a user to obtain permitted access to resources, according to at least one embodiment.

FIG. 2A illustrates a data hierarchy, according to at least one embodiment.

FIG. 2B illustrates a role, including multiple classes of roles, assigned to a user, according to at least one embodiment.

FIG. 3A illustrates a set of classes of rules with different actions for various permissions, according to at least one embodiment.

FIG. 3B illustrates an example authorization tree determined using classes of rules associated with a user and a role, according to at least one embodiment.

FIG. 3C illustrates an overall set of permissions for a role and corresponding to an authorization tree, according to at least one embodiment.

FIG. 3D illustrates a request tree, a response tree, and an authorization tree for a user, according to at least one embodiment.

FIG. 3E illustrates unrestricted flow of permissions to other nodes of a tree, according to at least one embodiment.

FIG. 3F illustrates restriction on flow of permissions in an authorization tree to prevent undesired inheritance of permissions on nodes of other branches, according to at least one embodiment.

FIG. 4A illustrates an example process for determining whether to authorize access for a request, according to at least one embodiment.

FIG. 4B illustrates an example process that can be performed to generate an authorization tree for a user and a role, according to at least one embodiment.

FIG. 4C illustrates an example process that can be performed to determine whether to grant access to a request by comparing a request tree and an authorization tree, according to at least one embodiment.

FIG. 4D illustrates an example process that can be performed to determine which data to return with a response by comparing a response tree and an authorization tree, according to at least one embodiment.

FIG. 5 illustrates an example data center system, according to at least one embodiment;

FIG. 6 is a block diagram illustrating a computer system, according to at least one embodiment;

FIG. 7 is a block diagram illustrating a computer system, according to at least one embodiment;

FIG. 8 illustrates a computer system, according to at least one embodiment;

FIG. 9 illustrates a computer system, according to at least one embodiment;

FIG. 10 illustrates exemplary integrated circuits and associated graphics processors, according to at least one embodiment;

FIGS. 11A, 11B illustrate exemplary integrated circuits and associated graphics processors, according to at least one embodiment;

FIG. 12 illustrates a computer system, according to at least one embodiment;

FIG. 13A illustrates a parallel processor, according to at least one embodiment;

FIG. 13B illustrates a partition unit, according to at least one embodiment;

FIG. 14 illustrates at least portions of a graphics processor, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles or machines, semi-autonomous or autonomous vehicles or machines (e.g., in one or more advanced driver assistance systems (ADAS), one or more in-vehicle infotainment systems, one or more emergency vehicle detection systems), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, generative AI, model training or updating, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, generative AI, cloud computing, and/or any other suitable applications.

Disclosed embodiments may be comprised in a variety of different systems such as automotive systems (e.g., an in-vehicle infotainment system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models--such as large language models (LLMs), systems for performing generative AI operations (e.g., using one or more language models), systems for performing light transport simulation, systems for performing collaborative content creation for 3D assets, systems implemented at least partially using cloud computing resources, and/or other types of systems.

Approaches in accordance with various illustrative embodiments can provide an efficient, accurate, and easy-to-use access control framework for shared resources. Such a framework can use data from any or all parts of a received request (e.g., a restful application programming interface (API) request), including the header and payload, to determine whether to grant access for the request, as well as to determine whether to filter any data from a response generated in response to the request. Users (or other authorized entities) can construct simple access rules, which can be aggregated in various combinations to produce custom authorization roles. A user can be assigned one of these roles, which can then cause that user to be associated with the corresponding set of rules for that role. An authorization tree can be generated based in part on the rules for a role, and this authorization tree can be used to determine whether to grant access for a received request. A role can include a set of classes, with each class holding a set of rules with associated paths and permissions, along with an action that specifies whether to allow or deny a request once a request endpoint is determined to match one of the paths of the class. In such a hierarchy, permissions flow in one direction and child nodes inherit permissions from their parent nodes. When a request is received on behalf of a given user, the request data (or a request tree generated using that data) can be extracted from all (or at least a subset of) relevant portions of the request and compared against the authorization tree, marching down the tree to find matching child nodes until an action is determined that is to be used to determine whether to grant access to the resource. In at least some embodiments, a response tree can also be generated and compared against the authorization tree to determine whether to allow certain data to be included in the response based in part upon the permissions associated with eh locations from which that data is to be obtained. Such approaches provide for faster and more effective access determinations, and provide such determinations to be made effectively at scale. Such an approach can work with various technologies, protocols, and environments, including Regex, Lightweight Directory Access Protocol (LDAP), TACACS+, RADIUS, and the like.

Variations of this and other such functionality can be used as well within the scope of the various embodiments as would be apparent to one of ordinary skill in the art in light of the teachings and suggestions contained herein.

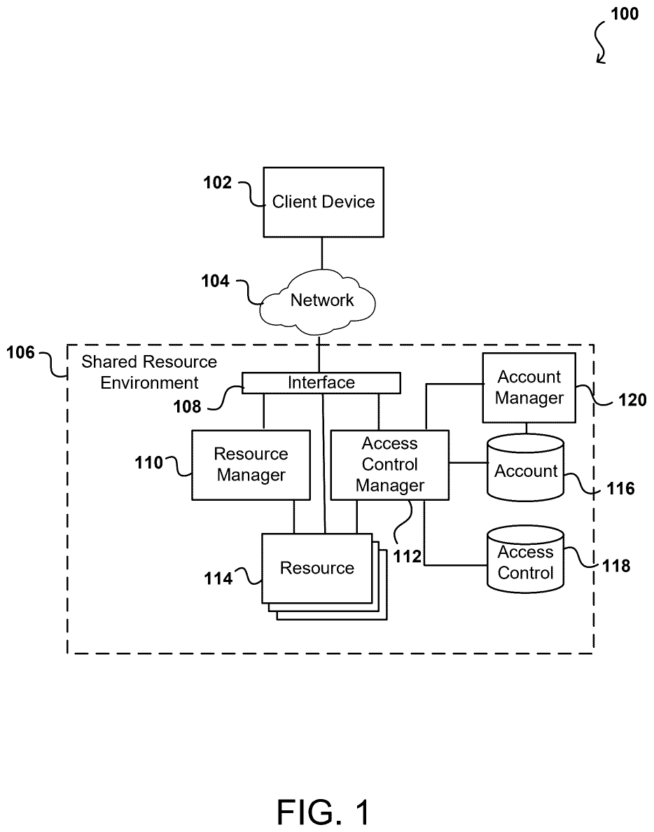

FIG. 1 illustrates an architecture 100 allowing for the use of resources in a shared resources environment, in accordance with at least one embodiment. In this example, a user is able to use a client device 102 to submit one or more requests to access one or more resources, or to perform a task using one or more resources, among other such options. The request can be submitted over at least one network 104, such as the Internet or a cellular network, and received to an interface, address, or endpoint in a shared resource environment 106. The request can be received to an interface, such as an application programming interface (API) of an interface layer 108, for example, which may include other networking devices as well, as may include routers, network switches, load balancers, and the like. In this example, a request from a client device 102 may first need to be analyzed to determine whether the client device, user, or other entity associated with the request has access to one or more resources to be used to process the request, as well as to determine whether the type of access permitted allows for performance of the requested operation.

In this example, information for the request can be directed to an access control manager 112, or other such component, system, or service. The access control manager 112 can perform various tasks to determine and/or manage access to a set of shared resources, such as to extract relevant information from a received request and compare information for the request against information in an account repository 116 or other such location. This operation can be used to determine whether the request is associated with a valid account associated with the shared resource environment, such as an account maintained by a user with a provider of the shared resource environment 106. One determined, that account information can be used to determine the type of access permissible to perform one or more operations associated with the request. This may include, for example, determining (or verifying) an authorized user identifier associated with the request, then using that user identifier to determine access permissions associated with that user identifier, as may be stored in an access control data repository 118 or other such location. In at least one embodiment, an access control manager 112 may include various modules to perform specific tasks, such as an authorization module and an authentication module, or may run on a network server that also has these modules available for use with the access control manager 112, among other such options.

Once a set of access permissions is identified that is associated with the request, the access control manager 112 (or an associated process) can determine whether the necessary permissions exist in the set to process the request which was received from the client device and associated with the user identifier. If the appropriate permissions are determined to exist or be available, the access control manager 112 can direct information for the request to one or more shared resources 114 (and/or potentially dedicated resources) in the shared resource environment 106. In some embodiments, the access control manager 112 may work with a resource manager to determine a specific instance of a type of resource to be used to perform an operation with respect to the request, where the resource manager 110 can perform other types of operations as needed, such as to allocate additional capacity of a type of resource, launch a new compute instance, or perform another such task associated with the request.

In some embodiments, access control may be determined, at least in part, using roles or privileges associated with individual users or accounts. In as least some embodiments, these roles or privileges may also be associated with groups of users, or users having one or more similar aspects. Such role-based access control can be used to provide or restrict authorization based in part on these roles or privileges, such as to allow or deny access to a scheme tree or resource endpoint based on one or more associated user roles. An account manager 120 can have the ability to open new accounts, or close or modify existing accounts, and update the relevant account information in an account repository 116. The account manager 120 may work with the access control manager 112 to update and/or apply permissions based in part on any changes or creation of an account. In at least one embodiment, each user (or other entity associated with an account) can be assigned at least one role. Roles may include static rules, such as system administrator or resource monitor, among other such roles. These role(s) applied to a set of users can determine the type of actions that a user is permitted to have performed in the shared resource environment 100. As an example, an administrator role might have access to modify and apply configuration changes, while a monitor role might have access to show commands on the system but is unable to modify or apply configuration changes. In at least some situations, it is desirable to provide more granular permissions on different parts of a given schema, which cannot be handled through the use of broad roles alone. For example, an administrator might want to allow or deny users from using certain command line interfaces (CLIs), protocol methods, or URIs, which may be difficult to accomplish using broad user roles.

Accordingly, approaches in accordance with various embodiments can allow for more granular control of access and authorization decisions, such as more granular control of object model authorization where certain users can only access certain parts of a given schema. These approaches can provide for per-command authorization for specific CLIs, APIs, and the like. Such approaches can also allow for reuse of authorization roles and classes, for example, and can avoid the need for long and/or many worded CLI prompts for user authorization. In at least one embodiment, a component or process such as an access control manager 112 can analyze multiple components of a request, such as a restful (“REST”) API request, instead of simply analyzing the target destination or endpoint for a request. This may include, for example, analyzing data in the header and payload of a request, among other such options. Such an approach can provide an easy-to-use model that can be used to configure multiple authorization rules at varying levels of granularity. A request inspection algorithm-particularly one that analyzes a request payload-can be used that also reduced the time complexity from an O(N)² problem (where the time complexity for the algorithm increases exponentially with input size) to an O(N) problem (where the time complexity increases proportionally with increases in input size), which can significantly improve overall system performance while ensuring proper security.

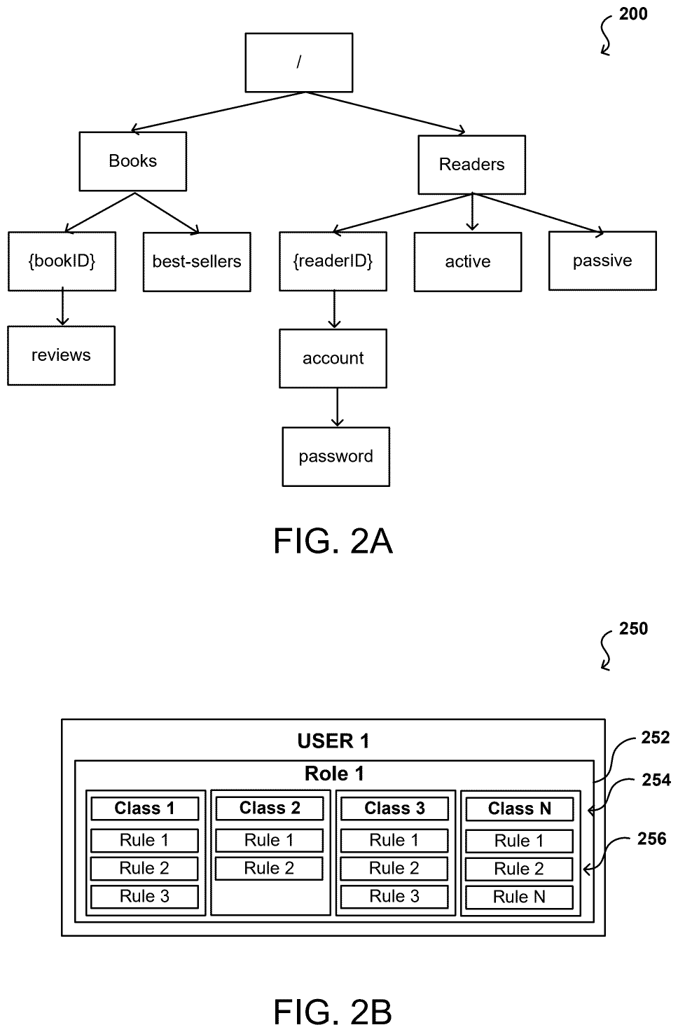

As an example, FIG. 2A illustrates an example library database schema that can be used to store data for a system. The schema is hierarchical, and includes a root node and many child nodes at various levels. In order to access a determined type of data, the tree can be traversed using parent-child relationships (or edges) until the target data is located. In many situations, this data may be stored at different locations, and there may be different permissions that apply to these different locations. Further, an access hierarchy will likely differ from the hierarchy of the schema, so that a given user may only have access to a portion of the data in this database, for a subset of nodes and levels of the hierarchy. An advantage of such a schema, however, is that is quickly allows the relevant data to be located.

Approaches in accordance with at least one embodiment can provide an access control model that a user, or other authorized entity, can use to configure a hierarchy of authorization rules. In at least one embodiment, such an authorization hierarchy can include levels of nodes corresponding to roles, classes, and rules, where there may be one authorization hierarchy generated per user per role. FIG. 2B illustrates an example user authorization model 250, where a user is assigned a role 252, and that role has several assigned classes 254. Each of these classes may also, in turn, have a respective set of rules 256 applied. Each class may hold a set of command paths (e.g., HTTP request paths) and permissions, defined by respective rules 256, along with an action. These classes can be reusable, which can help to reduce duplication and allow the authorization process to be reasonably dynamic.

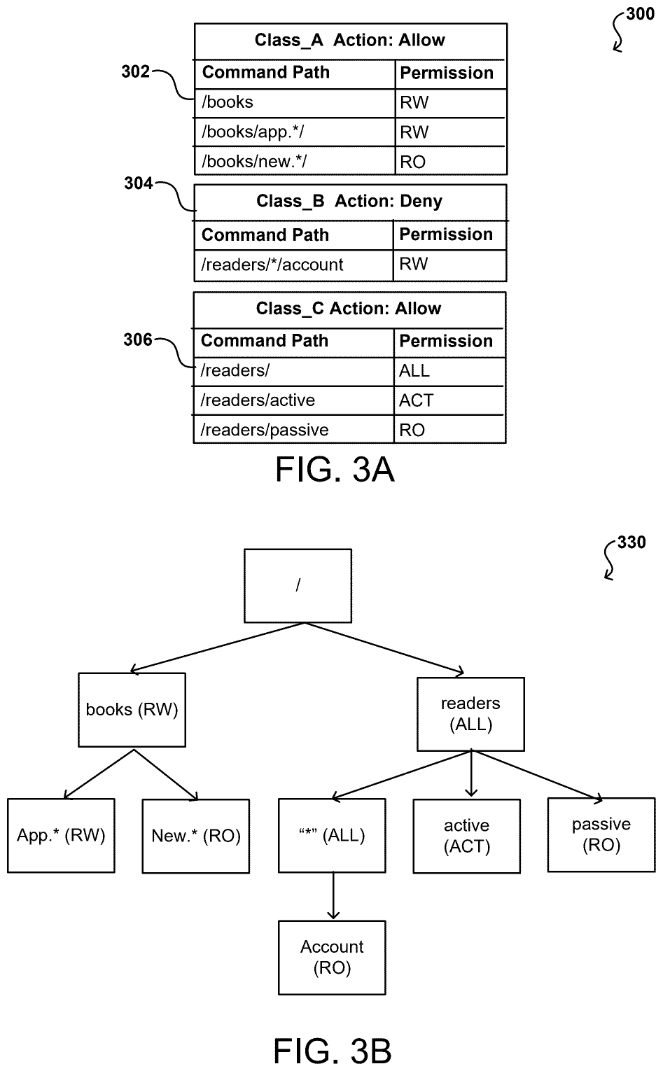

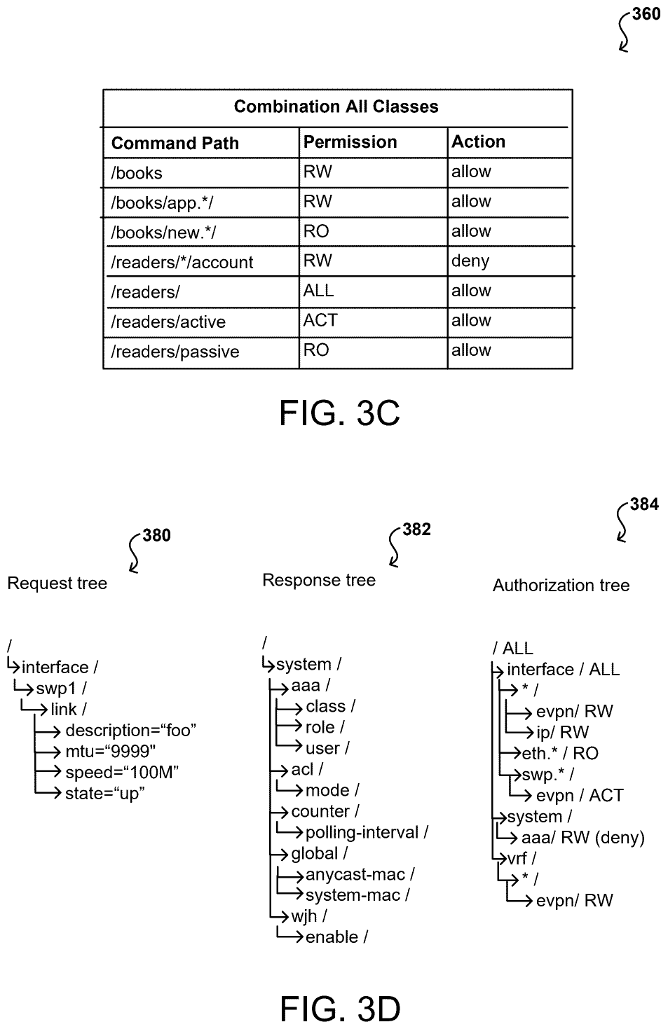

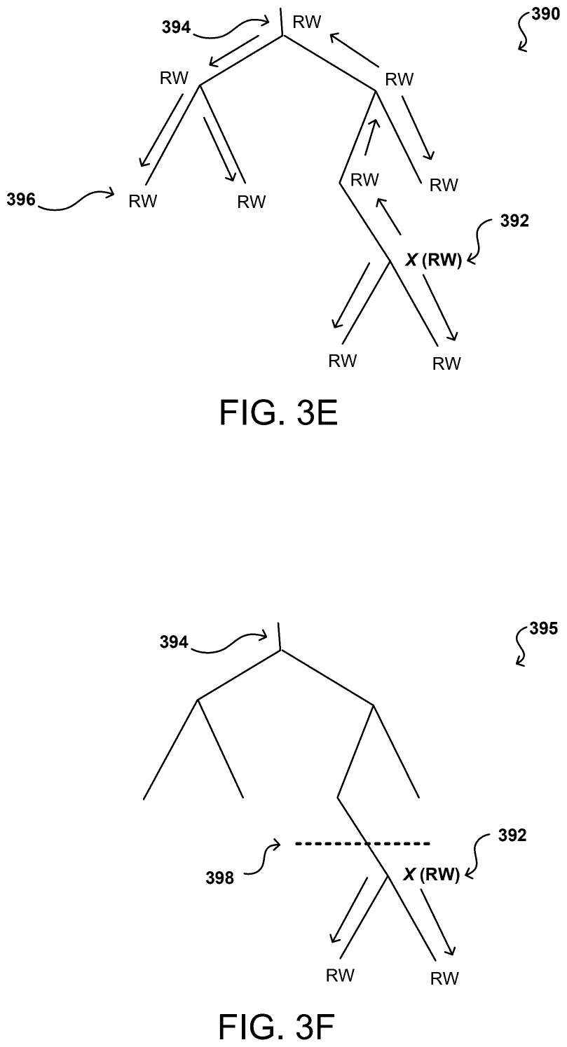

FIG. 3A illustrates an example set of classes 300 that can be defined in accordance with at least one embodiment. As mentioned, each class can have one or more rules indicating a set of command paths and permissions, as well as an action. A command path in at least one embodiment cannot have more allow permissions than a parent command path, and cannot have allow permissions that intersect with deny permissions on the same command path. Each command path can have its own permissions, including permissions such as (but not limited to) Read Only (GET), Read/Write (GET, PATCH, DELETE), ACTION (Action commands), or ALL (all flags). These permissions can function as flags, and any combination of these flags can be used. The default permission can be ALL. There can also be an action (e.g., allow or deny) which is defined at the class level.

A first class definition 302 for class A is illustrated in FIG. 3A, where there are respective permissions associated with each of a number of command paths. It should be understood that various permissions can be permitted with other addresses, locations, or resources as well, such as may correspond to interfaces, resource identifiers, resource classifications, addresses, and the like. In this model, child nodes in a permission hierarchy inherit permissions from the parent, and cannot expand beyond the permission granted to the parent. As illustrated, a books node has a read and write (R/W) permission applied. There are two child nodes listed under the books node, where one node also has a R/W permission, and the other node has a more restrictive read-only (RO) permission applied. A second class definition 304 for class B includes a deny action, such that users having this class of rules applied will be denied permission to perform read or write actions associate with the account nodes for any of the readers associated with the parent node. A third class definition 306 includes permissions for other command paths associated with other nodes, where it can be seen that permissions associated with parent nodes are never less restrictive than the permissions applied to any of their child nodes. In at least one embodiment an access control manager or other interface that allows for the definitions of such classes can analyzed proposed classes of rules to ensure that restrictiveness and other rules are respected, and if there is a conflict or rule violation then an error can be generated and the class of rules not adopted or approved for usage until the error is corrected, or conflict addressed, etc.

As illustrated, each of these classes has an associated “allow” or “deny” action. Other actions are possible as well in other embodiments. Each class then contains a list or set of one or more command paths, along with the permission for each path. As mentioned, each row can specify the permissions for which to perform the class action for the respective paths. It can be important to define which permissions are to be denied in addition to those which are to be allowed, as nodes in an authorization hierarchy inherit the permissions from their parent node. In the example classes of FIG. 3A, the/readers/path is illustrated to have all permissions allowed for this role. Unless Class B were associated with this role that indicated that read/write permission is to be denied for any account subfolder, the “allow all” permission from the parent node would be applied. A number of roles can be created using different combinations of classes that have different permissions. As stated elsewhere herein, when a class is to be added to a role, the individual rules can be checked to make sure that there are no conflicts. A notification may also be generated if the class will impact any other classes so the user can confirm the desired action. For example, since the child nodes inherit the permissions from the parent nodes, making a given node more restrictive will also cause the respective child nodes to also inherit that more restrictive set of permissions, which may not be intended. Further, a change to a node can be analyzed to ensure that the change does not cause the permissions for a given node to be less restrictive than that for a parent node, and if so can be rejected unless permission is also changed for the respective parent node(s). As mentioned, a child node can at most have the same permissions as a parent node in this scheme, and may have fewer permissions or permissions of a smaller scope, but may not have permissions that exceed those of any parent node in an authorization (or other such) tree. The ability for child nodes to inherit permissions of the respective parent nodes also reduces the amount of manual configuration to be performed, as permissions can automatically be applied to child nodes except where the permissions for those nodes is to differ from those applied to the parent node.

The set of classes and rules can then be used to (explicitly or implicitly) generate an authorization tree 330 as illustrated in FIG. 3B. In this example, the command paths are illustrated as a hierarchy of nodes, and the permissions are determined for each of the nodes, which can be inherited from a parent node if not otherwise specified. As illustrated, no parent node in the authorization tree has more restrictive permissions than any of its child nodes, whether direct or indirect child nodes.

The authorization tree 330 can also be expressed in table 360 or list form, as illustrated in FIG. 3C. This table 360 lists the various command paths, as well as the permissions and associated actions. Such an approach can quickly be used to determine the appropriate action and permission for a request based in part upon the command path associated with the request. Such an approach can be much faster than prior approaches, providing for significantly higher efficiency as discussed in more detail elsewhere herein. An authorization tree can be quickly analyzed to ensure that there are no conflicting or improper permissions, such as where a child node has less restrictive permissions than a parent node in the authorization tree.

An authorization tree can quickly be traversed using path information (as may be determined using payload information as discussed elsewhere herein) to determine the applicable permissions for that request. This can be particularly beneficial for endpoints such as REST API endpoints, for example, which may specify a single endpoint or multiple endpoints (or paths, etc.). In other embodiments, a request can attempt to perform multiple operations by specifying a root path or endpoint. For example, a user may attempt to change several properties on an interface, such as the link speed, link MTU, link description, and link state. This information may be specified in the payload, and an access control algorithm as disclosed herein can quickly identify this information in the payload and determine the appropriate permissions by traversing the relevant authorization tree.

When a request (or command, etc.) is received, the information in a request can be analyzed to determine the actions to be performed. As mentioned, this information can come from multiple different locations or portions of a request, such as from the payload in addition to the header and other such locations. In at least one embodiment, a request tree 380 can be created, such as is illustrated in FIG. 3D. Such a tree can help to quickly and clearly identify the type of access that is attempted to be obtained for a given request. Even if a request specifies multiple separate paths or CLIs, for example, a single request tree 380 can be generated for that request. Similarly, a response tree 382 can be generated that indicates the data to be returned in the response if the request were to be granted access, as well as the locations from which that data is to be obtained. The request tree 380 and the response tree 382 can then both be validated using the respective authorization tree 384 for the user associated with the request, as may be determined by a role associated with the user. In at least one embodiment, a validation process can walk each of the request tree 380 and the response tree 382 from root node to leaf node(s) and determine whether the type of access is permitted according to the corresponding portion of the authorization tree. A determination on whether to allow or deny the request can be made based on this comparison, as well as a determination as to whether to filter any of the data from the response based, at least in part, upon the respective permissions for that data. For nodes that are not present in the authorization tree, for example, the inheritance rule can be applied and any folder can be determined to inherit the permissions of the parent node unless otherwise specified.

In at least one embodiment, there may be some restrictions on the application of applied permissions to other nodes in a tree, such as an authorization tree as illustrated in the view 390 of FIG. 3E. In the example of FIG. 3E, a read/write (RW) permission may be applied to a given node x 392. In an approach where child nodes inherit permissions from a parent node, this RW permission may be applied to the child nodes of x. Because parent nodes in such an approach may also be required to be no more restrictive than any child node, this can cause the RW permission to be propagated up through the parent nodes of x as well, all the way up to a root node 394 of the tree. Because child nodes inherit the permissions of the parent nodes by default, the RW permission may then also end up being propagated down to the root nodes 396 of another branch of the tree. In many instances, it will not have been intended that such a permission be applied to other branches of the tree. Accordingly, an approach in accordance with at least one embodiment can prevent permissions from being applied automatically to certain other portions of the tree, such as parent nodes. An example restriction 398 is illustrated in the view 395 of FIG. 3F, where the RW permission applied to node x is not automatically applied up through the parent nodes of the tree. Because these nodes do not currently have specific permissions, there is no conflict or more restrictive permissions applied to the parent nodes. If an attempt was made to apply a more restrictive permission to a parent node, the conflict could be detected and handled appropriately, as discussed elsewhere herein. Such an approach can prevent other branches of the tree from inheriting permissions to one or more nodes of a specific branch. Other restrictions can be put in place at other locations in an authorization tree as well within the scope of various embodiments. In one example, a flag such as “are permissions set” can be applied to specific nodes, and if no permissions are set then the system can assume that there are no permissions to be inferred due to inheritance, permission restriction, or other such policies. An inheritance rule can thus apply only to those child nodes below where a permission is applied in a tree (unless also restricted).

Such an approach can have benefits for a variety of systems, including those where a system implements a CLI-first approach. In such an approach, CLIs may have supported initially and then later this scheme was updated to support APIs as well, including rest APIs. Any configuration in the system then may be designed for CLIs and then may need to be converted to support APIs. As mentioned, the APIs can be organized in a hierarchical organization so that the endpoints function as child nodes of the respective root and parent nodes. Such organization can present challenges when attempting to patch on a level of the hierarchy that is different from where access to the data is provided. An access control framework as presented herein can consist of a plurality of rules that can be created by users to indicate where a given user, account, or request should, and should not, have access, or at least certain types of access. The relevant rules can then be assigned to classes, as mentioned, and used to define an access scheme for a user role. A user role can then function as a virtual identity that can be associated with a number of rules. Rules can be added to, removed from, and reassigned between roles, and individual rules can potentially comprise multiple CLIs, among other such options.

As mentioned, there may be different types of roles, such as admin roles, manager roles, monitor roles, and the like, and each type of role should have different types of access at different levels or nodes in various implementations. When a user is attempting to access a resource in an access controlled system or environment, portions of the request (including the payload) can be analyzed to determine identifying information for the associated user, among other potentially useful information such as that discussed herein, and used to determine a role associated with that user. The rules under that role can then be used to determine whether to provide a certain type of access to a certain resource associated with the request. Such an approach does not provide a simple 1:1 mapping of access rules to users (or requests, etc.), but can allow for a 1:N mapping where various different rules can be mapped to a user and used to determine access for a variety of different resources (or resource endpoints) associated with a given user request. Such mappings can be particularly useful when using APIs that are hierarchical and have endpoints with various actions such as get, set, and patch, etc. Such an approach can also allow for easier management than approaches where there are a large number of 1:1 mappings, and can also be significantly easier to manage at scale.

In at least one embodiment, an access control algorithm can still look at the target address or method for a request, such as the URI endpoint or REST API endpoint specified in the request. The algorithm can, however, also look deeper into the data from the request, such as to analyze data in the payload of the request. Using prior approaches, analyzing a payload could be a very performance-intensive operation, particularly for large payloads. Further, since a payload is not required to adhere to a networking REST API schema the payload may not be hierarchical and thus may be difficult to analyze correctly and efficiently. Approaches as presented herein can provide for each of configuration, scalability, reusability, and upgradeability, among other such benefits.

Analyzing request data such as the payload can be beneficial to determine information such as an intent of a user. In one example, a user may attempt to perform a patch request. The request may be submitted that specifies a URI, an IP port, and an endpoint. The user may be attempting to change the speed on a network interface, which can be relatively straightforward. The request itself can include information needed to validate the user. As well as to determine whether the user has permission or access to change the speed on that specific interface. Using a component end view, it was observed that users can attempt to manipulate data or configuration such that the user can access an endpoint that is above a root endpoint. The same user information-such as the user identifier, password, IP address, and the like-could then be used to gain otherwise unauthorized access to an endpoint at a different level that should have a permission other than may have been granted for the request based solely on the URI or endpoint specified by the request. Without analyzing the payload for at least some requests, it may not be possible to determine the actual intent of the user. In at least some embodiments, the payload can include a set of JSON or YAML in hierarchical form. An access control algorithm can analyze the individual paths in the payload to determine that each task to be performed using a respective path is something that is permitted to be performed by the user. For example, it might be determined upon analyzing the payload of a request that a user is actually trying to change something on the system path, which is a path to which that user does not have access or permissions. This request can then be denied because the request contains something in the payload that is not authorized. Prior approaches that did not analyze the payload may have granted access for this request based on analyzing only other limited information for the request.

In another example, the potential responses can be analyzed and filtered using a role associated with a set of rules. A user might attempt to do a show command on a system global path. Looking at the endpoint, the system can determine that this user has access to perform a show command on that path, and can grant access. In a given request, however, the user may attempt a GET request (or similar operation) on a path associated with a parent node-such as a system path. Using a hierarchical scheme as presented herein, the system can quickly determine the type of access permitted for nodes at each of a set of levels, including child and parent nodes which may have different permissions associated with different rules. The response can be filtered using the relevant rules so that the user only receives information from folders where the user has GET-type access. This may prevent the user from being able to get data from one or more subfolders where the user does not have that type of access permitted. In such an approach, a user may be granted access to a folder or path at a certain level, but the response returned or action taken can be filtered or limited to only data associated with folders or paths where the user has that type of access permitted.

Further, a user in many systems can have the ability to run several commands together, such as a batch of set commands. In prior approaches, it would be necessary to analyze each individual command or request against all of the rules that may be applicable, which as mentioned elsewhere herein creates an O(N)² problem where the run time or space requirements grow exponentially as the input size increases. Approaches as presented herein can use an authorization hierarchy generated using the applicable set of rules, which can allow for the appropriate access rule to be quickly determined for any given input without having to analyze all the individual rules. The applicable authorization tree can be determined based on the role of the user (with one authorization tree per user, per role), and can be generated using the relevant classes of user-defined (or other such) rules. Such an approach also has a benefit of being able to reuse classes of rules for different users or roles, such that the entire process does not need to be replicated or duplicated for each individual user. When an authorization tree is created and associated with a user assigned a given role, that authorization tree can then be cached at the relevant access control manager (or other such component or process) so that the tree is readily available for quick access decisions. If any aspects of a role change, the authorization tree will be updated (or a new authorization tree created) and verified, and the prior authorization tree will be invalidated and removed from cache. This can occur automatically, such as where a new class of rules is added to a role.

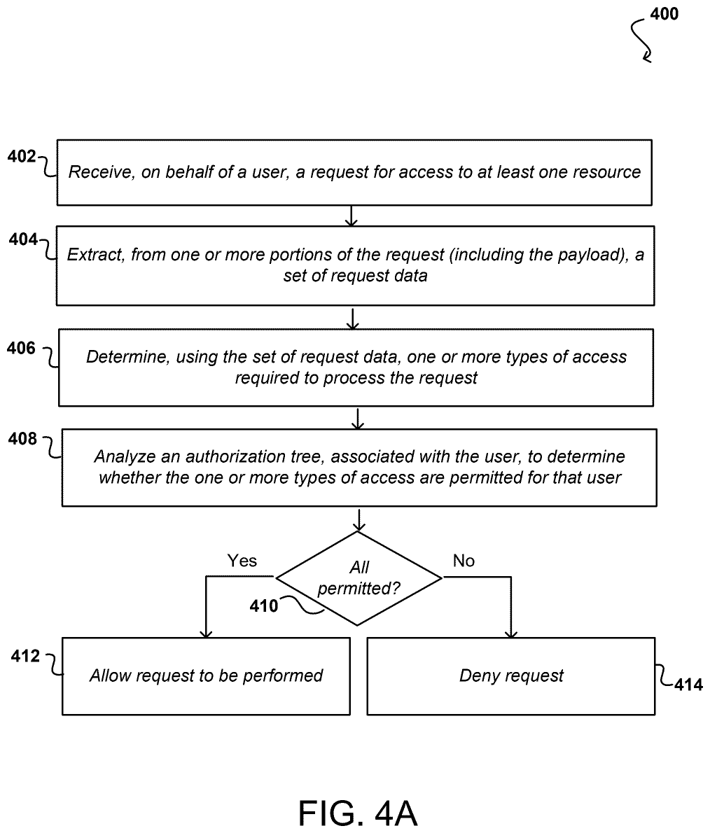

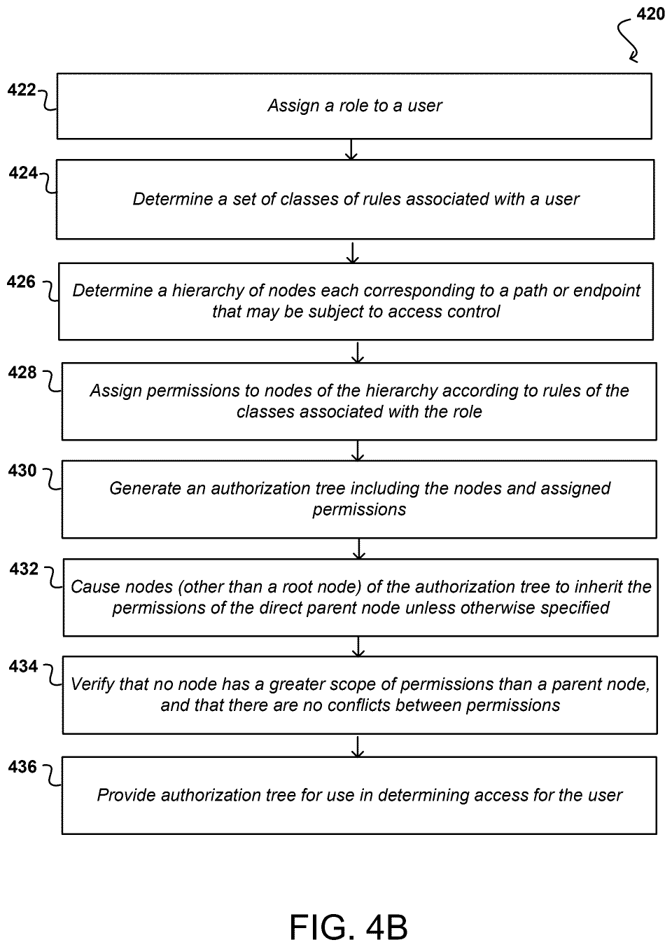

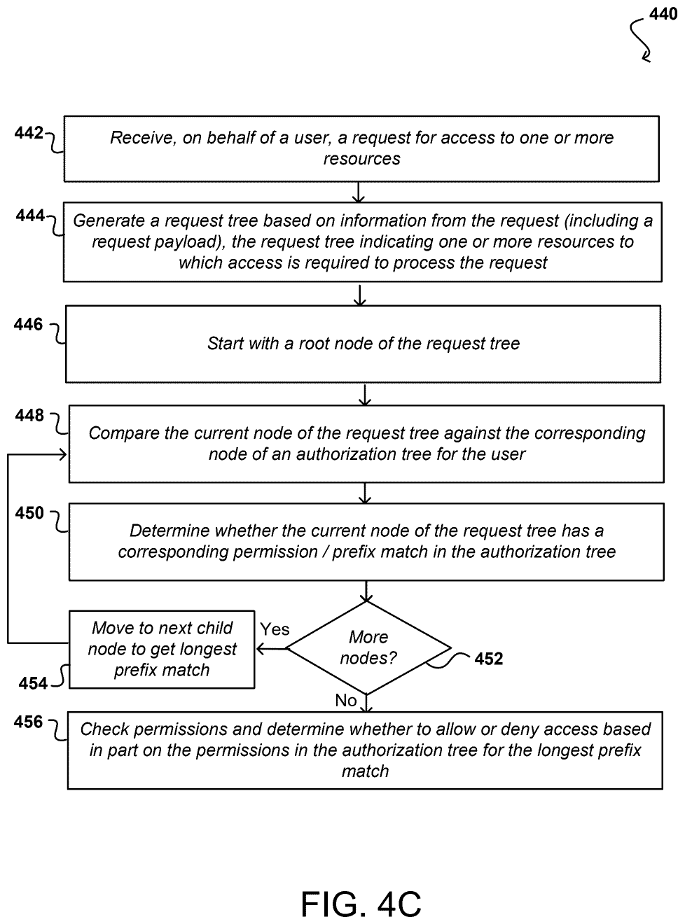

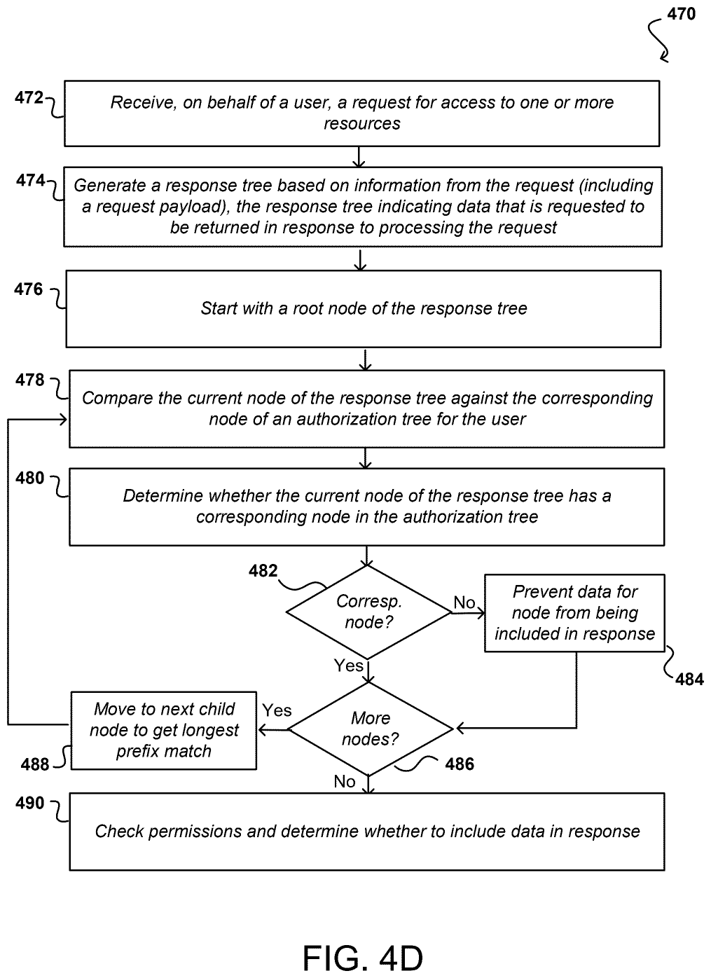

FIG. 4A illustrates an example process 400 that can be performed to determine access for a request, in accordance with at least one embodiment. It should be understood that for this and other processes discussed herein that there may be additional, fewer, or alternative steps performed in similar or alternative orders, or at least partially in parallel, within the scope of the various embodiments. Further, although discussed with respect to REST APIs and CLIs, for example, it should be understood that advantages of such a process can be obtained for other types of resources or access endpoints as well within the scope of various embodiments. In this example process, a request can be received 402 on behalf of (or otherwise associated with) a user or other entity having at least some level of access to resources in a shared resource environment. In at least one embodiment, the request can go through at least one authentication and authorization process to validate the request before any substantive processing. A set of request data can be extracted 404 from one or more portions of the request, such as may include at least a header and payload portion, among other such options. The set of request data can be used to determine 406 one or more types of access required to process the request. This may include analyzing the data to determine command paths relevant to the request, and determining a longest path prefix match for the request in at least one embodiment. An authorization tree can be identified that is associated with the user based, at least in part, upon a role assigned to the user, and the authorization tree can be analyzed 408 to determine whether the one or more types of access are permitted for that user. The authorization tree can include nodes with various paths, permissions, and actions, and at least one target node can be identified that includes the appropriate permission and action to take for a request based in part on the determined path. If it is determined 410 that the necessary type (or types) of access are permitted, then the request can be allowed 412 to be performed. If any of the required access is determined 410 to not be permitted, then the request can be denied 414. The denial may or may not include any information about the reason for denial, as such information may be helpful for a legitimate user but may provide helpful information to a user attempting to bypass access controls or perform another such undesired action.

As mentioned, such a process can be performed using an authorization tree. FIG. 4B illustrates an example process 420 that can be used to generate such an authorization tree in accordance with at least one embodiment. In this example, a role can be assigned 422 to a user, where that role might correspond to a manager, administrator, or other such set of responsibilities. Based at least in part on that role and/or set of responsibilities, a set of classes of access rules can be determined 424 that should apply to that user. This may include, for example, which actions are to be allowed for specifically denied for certain command paths, endpoints, or other such resources or locations. A hierarchy of path nodes can be determined 426, where individual nodes can correspond to a path or endpoint that may be subject to access control. Permissions can be assigned 428 to individual nodes according to the classes of rules that are associated with the role. For example, a rule can specify a specific permission and action for a specific command path or endpoint. An authorization tree can be generated 430 that includes this hierarchy of path nodes and the assigned permissions. As there may not be a specific rule for each individual node of the authorization tree, individual nodes (other than the root node) of the authorization tree can be caused 432 to inherit the permissions of at least the direct parent node, unless otherwise specified by an applicable rule. Once the permissions have been determined (or are able to be determined) for the individual nodes, the authorization tree can be analyzed to verify 434 that no node of the tree has a greater scope of permissions than a parent node, and that there are no conflicts or improper intersections of permissions. If any such issues are identified then the authorization tree can be rejected and/or a notification generated that identifies the issue(s) to be addressed. If no such issues are identified, then the authorization tree can be provided 436 for use in determining access for the associated user. As mentioned, in at least one embodiment there can be an authorization tree created per user and per role, as a user may have multiple roles and there may be different users who have the same role.

As part of an access control process, an approach in accordance with at least one embodiment can determine permissions in part by comparing a request tree against an authorization tree for a user. FIG. 4C illustrates an example process 440 that can be performed to generate and use a request tree to determine whether to grant access for a received request. In this example, a request is received 442 on behalf of a user that requires access to one or more resources, as may be associated with a command path or interface. A request tree can then be generated 444 based in part on information from the request, including information extracted from a request payload. The request tree can indicate one or more resources to which access is required to process the request, or may be used to determine an actual resource or endpoint to which a request requires access, among other such options. In order to determine whether to grant access for the request, the request tree can be compared to an authorization tree for the user starting 446 with a root node of the request tree. The current node of the request tree can be compared 448 against the nodes of the authorization tree for the user. It can be determined 450 whether a corresponding node with a prefix match and/or at least one permissions (which may be inherited from a parent node) exists in the authorization tree with respect to the current node of the request tree. A determination 452 can be made as to whether there are more nodes of the request tree to analyze. If so, then the process can move 454 to the next child node to, for example, get the longest prefix match from the analyzed nodes. The process can continue by traversing the request tree until it is determined 452 that there are no more nodes to be evaluated. At that point, the permissions associated with the longest prefix match can be checked 456 to determine whether to allow or deny access for the request. As mentioned, the actual endpoint for which permissions are to be determined may be different from the endpoint generally specified by the request, such as where the actual resource is associated with a child node or sub-endpoint of the resource environment. If there is no prefix match determined, the request can be denied.

Similarly, a request tree can be generated that can be compared against an authorization tree to determine whether to restrict certain data from being included in a response, if a response is permitted to be generated at all based on the relevant permissions. FIG. 4D illustrates an example process 470 that can be performed to generate and use a response tree to determine whether to provide data in a response generated for a received request. In this example, a request is received 472 on behalf of a user that requires access to one or more resources, as may be associated with a command path or interface. A response tree can then be generated 474 based in part on information from the request, including information extracted from a request payload. The response tree can indicate one or more instances of data (or data from one or more specific locations) that is requested to be returned (or used to generate other data) in response to processing the request, among other such options. In order to determine whether to include certain data in a response to the request, the response tree can be compared to an authorization tree for the user starting 476 with a root node of the response tree. The current node of the request tree can be compared 478 against the nodes of the authorization tree for the user. It can be determined 480 whether a corresponding node exists in the authorization tree with respect to the current node of the response tree. If it is determined 482 that there is no such corresponding node, then data from that node can be prevented 484 from being included in a response. If, however, it is determined that there is a corresponding node, then another determination 486 can be made as to whether there are more nodes of the response tree to analyze. If so, then the process can move 488 to the next child node to, for example, get the longest prefix match from the analyzed nodes. The process can continue by traversing the response tree until it is determined 486 that there are no more nodes to be evaluated. At that point, the permissions associated with the longest prefix match can be checked 490 to determine whether to include the (not yet excluded) data from being returned in a response. As mentioned, the actual endpoint for which permissions are to be determined may be different from the endpoint generally specified by the request, such as where the actual resource is associated with a child node or sub-endpoint of the resource environment.

In at least some of these examples, the computing and/or electronic devices that may request or obtain access to various resources can include a variety of different devices, as may include a desktop computer, notebook computer, set-top box, streaming device, gaming console, smartphone, tablet computer, VR headset, AR goggles, wearable computer, or a smart television. In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device or may incorporate one or more Virtual Machines (VMs). In at least one embodiment, such a system can be implemented at least partially in a data center or at least partially using cloud computing resources.

### Data Center

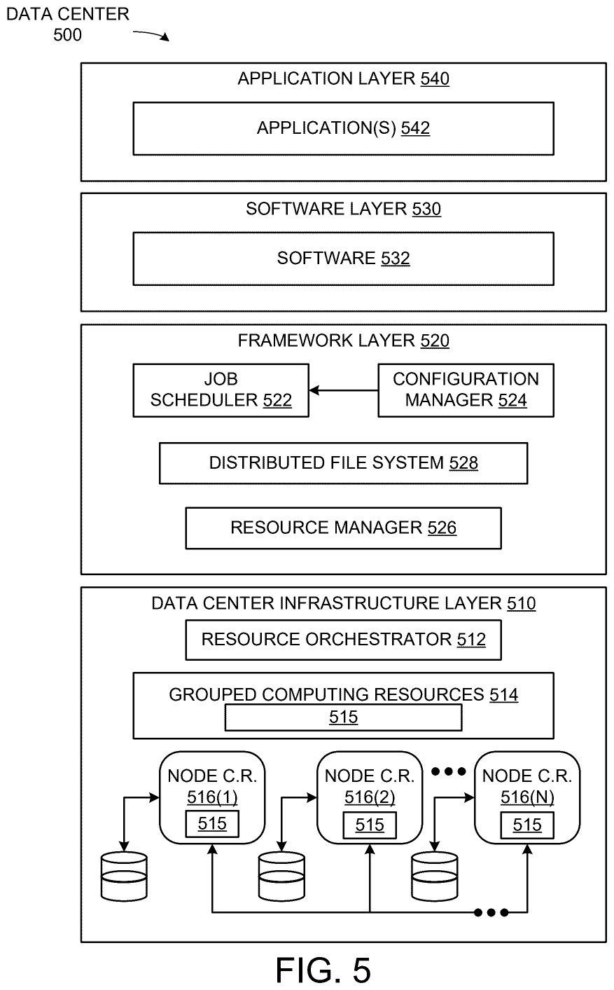

FIG. 5 illustrates an example data center 500, in which at least one embodiment may be used. In at least one embodiment, data center 500 includes a data center infrastructure layer 510, a framework layer 520, a software layer 530 and an application layer 540.

In at least one embodiment, as shown in FIG. 5, data center infrastructure layer 510 may include a resource orchestrator 512, grouped computing resources 514, and node computing resources (“node C.R.s”) 516(1)-516(N), where “N” represents a positive integer (which may be a different integer “N” than used in other figures). In at least one embodiment, node C.R.s 516(1)-516(N) may include, but are not limited to, any number of central processing units (“CPUs”) or other processors (including accelerators, field programmable gate arrays (FPGAs), graphics processors, etc.), memory storage devices 518(1)-518(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 516(1)-816(N) may be a server having one or more of above-mentioned computing resources.

In at least one embodiment, grouped computing resources 514 may include separate groupings of node C.R.s housed within one or more racks (not shown), or many racks housed in data centers at various geographical locations (also not shown). In at least one embodiment, separate groupings of node C.R.s within grouped computing resources 514 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 512 may configure or otherwise control one or more node C.R.s 516(1)-516(N) and/or grouped computing resources 514. In at least one embodiment, resource orchestrator 512 may include a software design infrastructure (“SDI”) management entity for data center 500. In at least one embodiment, resource orchestrator 512 may include hardware, software or some combination thereof.

In at least one embodiment, as shown in FIG. 5, framework layer 520 includes a job scheduler 522, a configuration manager 524, a resource manager 526 and a distributed file system 528. In at least one embodiment, framework layer 520 may include a framework to support software 532 of software layer 530 and/or one or more application(s) 542 of application layer 540. In at least one embodiment, software 532 or application(s) 542 may respectively include web-based service software or applications, such as those provided by Amazon Web Services, Google Cloud and Microsoft Azure. In at least one embodiment, framework layer 520 may be, but is not limited to, a type of free and open-source software web application framework such as Apache Spark™ (hereinafter “Spark”) that may utilize distributed file system 528 for large-scale data processing (e.g., “big data”). In at least one embodiment, job scheduler 522 may include a Spark driver to facilitate scheduling of workloads supported by various layers of data center 500. In at least one embodiment, configuration manager 524 may be capable of configuring different layers such as software layer 530 and framework layer 520 including Spark and distributed file system 528 for supporting large-scale data processing. In at least one embodiment, resource manager 526 may be capable of managing clustered or grouped computing resources mapped to or allocated for support of distributed file system 528 and job scheduler 522. In at least one embodiment, clustered or grouped computing resources may include grouped computing resources 514 at data center infrastructure layer 510. In at least one embodiment, resource manager 526 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 528 of framework layer 520. In at least one embodiment, one or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516(N), grouped computing resources 514, and/or distributed file system 528 of framework layer 520. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 524, resource manager 526, and resource orchestrator 512 may implement any number and type of self-modifying actions based on any amount and type of data acquired in any technically feasible fashion. In at least one embodiment, self-modifying actions may relieve a data center operator of data center 500 from making possibly bad configuration decisions and possibly avoiding underutilized and/or poor performing portions of a data center.

In at least one embodiment, data center 500 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 500. In at least one embodiment, trained machine learning models corresponding to one or more neural networks may be used to infer or predict information using resources described above with respect to data center 500 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. In at least one embodiment, inference and/or training logic 515 may be used in system FIG. 5 for inferencing or predicting operations based, at least in part, on weight parameters calculated using neural network training operations, neural network functions and/or architectures, or neural network use cases described herein.

Embodiments presented herein can provide for the determination of whether to grant access to a user request using an authorization tree generated using classes of user-defined rules associated with a role assigned to a respective user.

### Computer Systems

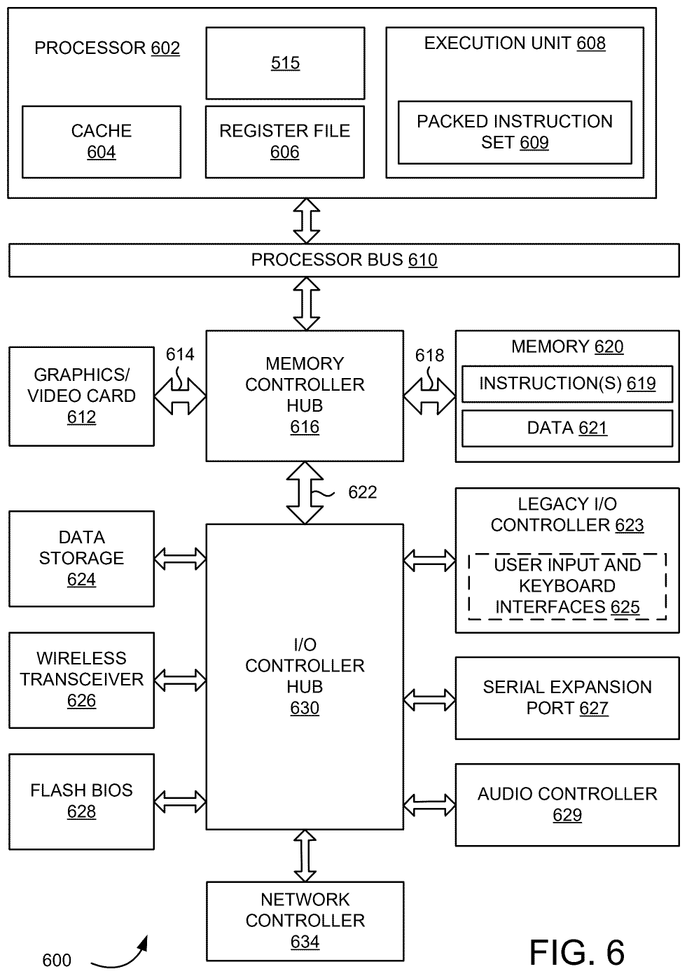

FIG. 6 is a block diagram illustrating an exemplary computer system, which may be a system with interconnected devices and components, a system-on-a-chip (SOC) or some combination thereof formed with a processor that may include execution units to execute an instruction, according to at least one embodiment. In at least one embodiment, a computer system 600 may include, without limitation, a component, such as a processor 602 to employ execution units including logic to perform algorithms for process data, in accordance with present disclosure, such as in embodiment described herein. In at least one embodiment, computer system 600 may include processors, such as PENTIUM® Processor family, Xeon™, Itanium®, Scale™ and/or StrongARM™, Intel® Core™, or Intel® Nirvana™ microprocessors available from Intel Corporation of Santa Clara, California, although other systems (including PCs having other microprocessors, engineering workstations, set-top boxes and like) may also be used. In at least one embodiment, computer system 600 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“Necks”), set-top boxes, network hubs, wide area network (“WAN”) switches, or any other system that may perform one or more instructions in accordance with at least one embodiment.

In at least one embodiment, computer system 600 may include, without limitation, processor 602 that may include, without limitation, one or more execution units 608 to perform machine learning model training and/or inferencing according to techniques described herein. In at least one embodiment, computer system 600 is a single processor desktop or server system, but in another embodiment, computer system 600 may be a multiprocessor system. In at least one embodiment, processor 602 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 602 may be coupled to a processor bus 610 that may transmit data signals between processor 602 and other components in computer system 600.

In at least one embodiment, processor 602 may include, without limitation, a Level 1 (“L1”) internal cache memory (“cache”) 604. In at least one embodiment, processor 602 may have a single internal cache or multiple levels of internal cache. In at least one embodiment, cache memory may reside external to processor 602. Other embodiments may also include a combination of both internal and external caches depending on particular implementation and needs. In at least one embodiment, a register file 606 may store different types of data in various registers including, without limitation, integer registers, floating point registers, status registers, and an instruction pointer register.

In at least one embodiment, execution unit 608, including, without limitation, logic to perform integer and floating point operations, also resides in processor 602. In at least one embodiment, processor 602 may also include a microcode (“code”) read only memory (“ROM”) that stores microcode for certain macro instructions. In at least one embodiment, execution unit 608 may include logic to handle a packed instruction set 609. In at least one embodiment, by including packed instruction set 609 in an instruction set of a general-purpose processor, along with associated circuitry to execute instructions, operations used by many multimedia applications may be performed using packed data in processor 602. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, execution unit 608 may also be used in microcontrollers, embedded processors, graphics devices, DSPs, and other types of logic circuits. In at least one embodiment, computer system 600 may include, without limitation, a memory 620. In at least one embodiment, memory 620 may be a Dynamic Random Access Memory (“DRAM”) device, a Static Random Access Memory (“SRAM”) device, a flash memory device, or another memory device. In at least one embodiment, memory 620 may store instruction(s) 619 and/or data 621 represented by data signals that may be executed by processor 602.

In at least one embodiment, a system logic chip may be coupled to processor bus 610 and memory 620. In at least one embodiment, a system logic chip may include, without limitation, a memory controller hub (“MCH”) 616, and processor 602 may communicate with MCH 616 via processor bus 610. In at least one embodiment, MCH 616 may provide a high bandwidth memory path 618 to memory 620 for instruction and data storage and for storage of graphics commands, data, and textures. In at least one embodiment, MCH 616 may direct data signals between processor 602, memory 620, and other components in computer system 600 and to bridge data signals between processor bus 610, memory 620, and a system I/O interface 622. In at least one embodiment, a system logic chip may provide a graphics port for coupling to a graphics controller. In at least one embodiment, MCH 616 may be coupled to memory 620 through high bandwidth memory path 618 and a graphics/video card 612 may be coupled to MCH 616 through an Accelerated Graphics Port (“AGP”) interconnect 614.

In at least one embodiment, computer system 600 may use system I/O interface 622 as a proprietary hub interface bus to couple MCH 616 to an I/O controller hub (“ICH”) 630. In at least one embodiment, ICH 630 may provide direct connections to some I/O devices via a local I/O bus. In at least one embodiment, a local I/O bus may include, without limitation, a high-speed I/O bus for connecting peripherals to memory 620, a chipset, and processor 602. Examples may include, without limitation, an audio controller 629, a firmware hub (“flash BIOS”) 628, a wireless transceiver 626, a data storage 624, a legacy I/O controller 623 containing user input and keyboard interfaces 625, a serial expansion port 627, such as a Universal Serial Bus (“USB”) port, and a network controller 634. In at least one embodiment, data storage 624 may comprise a hard disk drive, a floppy disk drive, a CD-ROM device, a flash memory device, or other mass storage device.

In at least one embodiment, FIG. 6 illustrates a system, which includes interconnected hardware devices or “chips”, whereas in other embodiments, FIG. 6 may illustrate an exemplary SoC In at least one embodiment, devices illustrated in FIG. 6 may be interconnected with proprietary interconnects, standardized interconnects (e.g., PCIe) or some combination thereof. In at least one embodiment, one or more components of computer system 600 are interconnected using compute express link (CXL) interconnects.

Inference and/or training logic 515 are used to perform inferencing and/or training operations associated with one or more embodiments. In at least one embodiment, inference and/or training logic 515 may be used in system FIG. 6 for inferencing or predicting operations based, at least in part, on weight parameters calculated using neural network training operations, neural network functions and/or architectures, or neural network use cases described herein.

Embodiments presented herein can provide for the determination of whether to grant access to a user request using an authorization tree generated using classes of user-defined rules associated with a role assigned to a respective user.

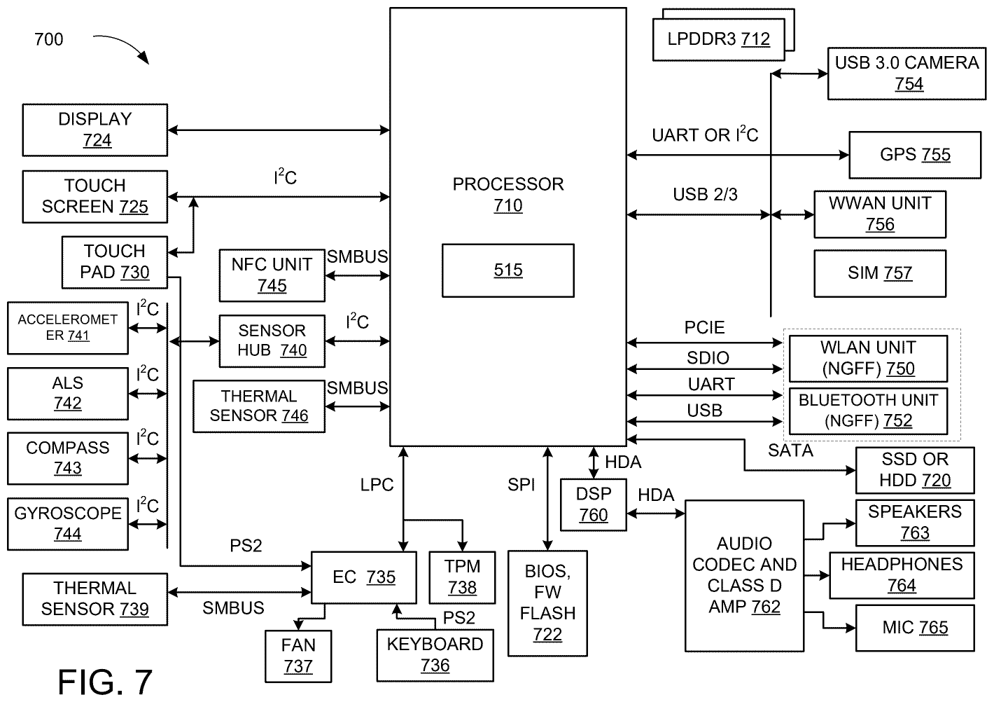

FIG. 7 is a block diagram illustrating an electronic device 700 for utilizing a processor 710, according to at least one embodiment. In at least one embodiment, electronic device 700 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 700 may include, without limitation, processor 710 communicatively coupled to any suitable number or kind of components, peripherals, modules, or devices. In at least one embodiment, processor 710 is coupled using a bus or interface, such as a I²C bus, a System Management Bus (“Sambas”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3, etc.), or a Universal Asynchronous Receiver/Transmitter (“UART”) bus. In at least one embodiment, FIG. 7 illustrates a system, which includes interconnected hardware devices or “chips”, whereas in other embodiments, FIG. 7 may illustrate an exemplary SoC. In at least one embodiment, devices illustrated in FIG. 7 may be interconnected with proprietary interconnects, standardized interconnects (e.g., PCIe) or some combination thereof. In at least one embodiment, one or more components of FIG. 7 are interconnected using compute express link (CXL) interconnects.

In at least one embodiment, FIG. 7 may include a display 724, a touch screen 725, a touch pad 730, a Near Field Communications unit (“NFC”) 745, a sensor hub 740, a thermal sensor 746, an Express Chipset (“EC”) 735, a Trusted Platform Module (“TPM”) 738, BIOS/firmware/flash memory (“BIOS, FW Flash”) 722, a DSP 760, a drive 720 such as a Solid State Disk (“SSD”) or a Hard Disk Drive (“HDD”), a wireless local area network unit (“WLAN”) 750, a Bluetooth unit 752, a Wireless Wide Area Network unit (“WWAN”) 756, a Global Positioning System (GPS) unit 755, a camera (“USB 3.0 camera”) 754 such as a USB 3.0 camera, and/or a Low Power Double Data Rate (“LPDDR”) memory unit (“LPDDR3”) 715 implemented in, for example, an LPDDR3 standard. These components may each be implemented in any suitable manner.

In at least one embodiment, other components may be communicatively coupled to processor 710 through components described herein. In at least one embodiment, an accelerometer 741, an ambient light sensor (“ALS”) 742, a compass 743, and a gyroscope 744 may be communicatively coupled to sensor hub 740. In at least one embodiment, a thermal sensor 739, a fan 737, a keyboard 736, and touch pad 730 may be communicatively coupled to EC 735. In at least one embodiment, speakers 763, headphones 764, and a microphone (“mic”) 765 may be communicatively coupled to an audio unit (“audio codec and class D amp”) 762, which may in turn be communicatively coupled to DSP 760. In at least one embodiment, audio unit 762 may include, for example and without limitation, an audio coder/decoder (“codec”) and a class D amplifier. In at least one embodiment, a SIM card (“SIM”) 757 may be communicatively coupled to WWAN unit 756. In at least one embodiment, components such as WLAN unit 750 and Bluetooth unit 752, as well as WWAN unit 756 may be implemented in a Next Generation Form Factor (“NGFF”).

Inference and/or training logic 515 are used to perform inferencing and/or training operations associated with one or more embodiments. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

Embodiments presented herein can provide for the determination of whether to grant access to a user request using an authorization tree generated using classes of user-defined rules associated with a role assigned to a respective user.

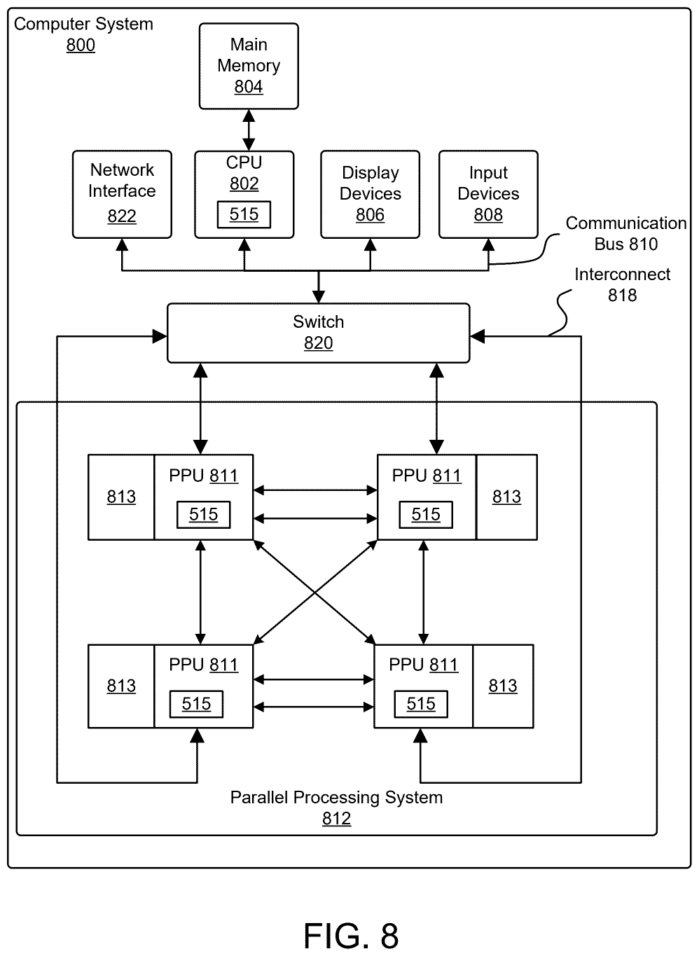

FIG. 8 illustrates a computer system 800, according to at least one embodiment. In at least one embodiment, computer system 800 is configured to implement various processes and methods described throughout this disclosure.

In at least one embodiment, computer system 800 comprises, without limitation, at least one central processing unit (“CPU”) 802 that is connected to a communication bus 810 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 800 includes, without limitation, a main memory 804 and control logic (e.g., implemented as hardware, software, or a combination thereof) and data are stored in main memory 804, which may take form of random access memory (“RAM”). In at least one embodiment, a network interface subsystem (“network interface”) 822 provides an interface to other computing devices and networks for receiving data from and transmitting data to other systems with computer system 800.

In at least one embodiment, computer system 800, in at least one embodiment, includes, without limitation, input devices 808, a parallel processing system 812, and display devices 806 that can be implemented using a conventional cathode ray tube (“CRT”), a liquid crystal display (“LCD”), a light emitting diode (“LED”) display, a plasma display, or other suitable display technologies. In at least one embodiment, user input is received from input devices 808 such as keyboard, mouse, touchpad, microphone, etc. In at least one embodiment, each module described herein can be situated on a single semiconductor platform to form a processing system.

Inference and/or training logic 515 are used to perform inferencing and/or training operations associated with one or more embodiments. In at least one embodiment, inference and/or training logic 515 may be used in system FIG. 8 for inferencing or predicting operations based, at least in part, on weight parameters calculated using neural network training operations, neural network functions and/or architectures, or neural network use cases described herein.

Embodiments presented herein can provide for the determination of whether to grant access to a user request using an authorization tree generated using classes of user-defined rules associated with a role assigned to a respective user.

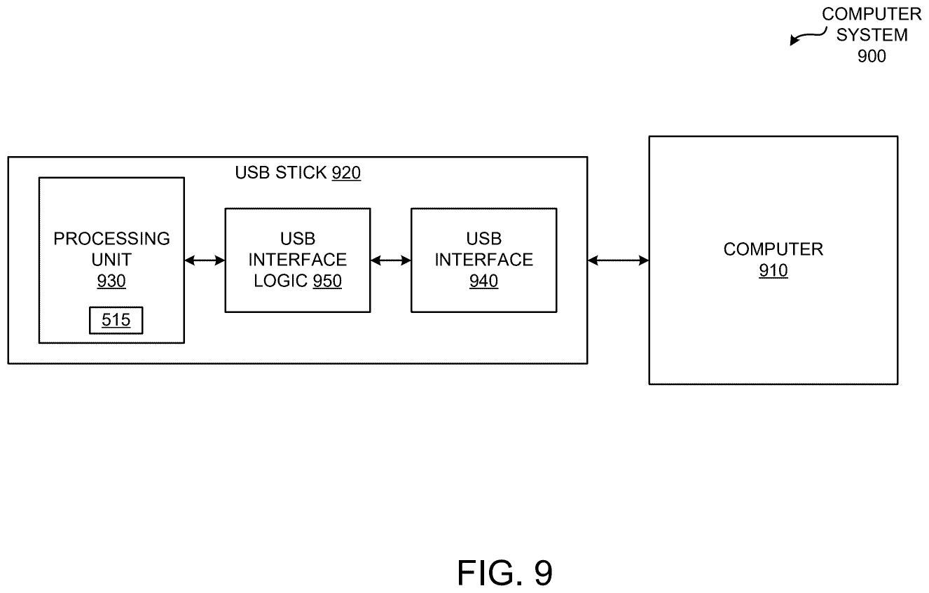

FIG. 9 illustrates a computer system 900, according to at least one embodiment. In at least one embodiment, computer system 900 includes, without limitation, a computer 910 and a USB stick 920. In at least one embodiment, computer 910 may include, without limitation, any number and type of processor(s) (not shown) and a memory (not shown). In at least one embodiment, computer 910 includes, without limitation, a server, a cloud instance, a laptop, and a desktop computer.

In at least one embodiment, USB stick 920 includes, without limitation, a processing unit 930, a USB interface 940, and USB interface logic 950. In at least one embodiment, processing unit 930 may be any instruction execution system, apparatus, or device capable of executing instructions. In at least one embodiment, processing unit 930 may include, without limitation, any number and type of processing cores (not shown). In at least one embodiment, processing unit 930 comprises an application specific integrated circuit (“ASIC”) that is optimized to perform any amount and type of operations associated with machine learning. For instance, in at least one embodiment, processing unit 930 is a tensor processing unit (“TPC”) that is optimized to perform machine learning inference operations. In at least one embodiment, processing unit 930 is a vision processing unit (“VPU”) that is optimized to perform machine vision and machine learning inference operations.

In at least one embodiment, USB interface 940 may be any type of USB connector or USB socket. For instance, in at least one embodiment, USB interface 940 is a USB 3.0 Type-C socket for data and power. In at least one embodiment, USB interface 940 is a USB 3.0 Type-A connector. In at least one embodiment, USB interface logic 950 may include any amount and type of logic that enables processing unit 930 to interface with devices (e.g., computer 910) via USB connector 940.

Inference and/or training logic 515 are used to perform inferencing and/or training operations associated with one or more embodiments. In at least one embodiment, inference and/or training logic 515 may be used in system FIG. 9 for inferencing or predicting operations based, at least in part, on weight parameters calculated using neural network training operations, neural network functions and/or architectures, or neural network use cases described herein.

Embodiments presented herein can provide for the determination of whether to grant access to a user request using an authorization tree generated using classes of user-defined rules associated with a role assigned to a respective user.

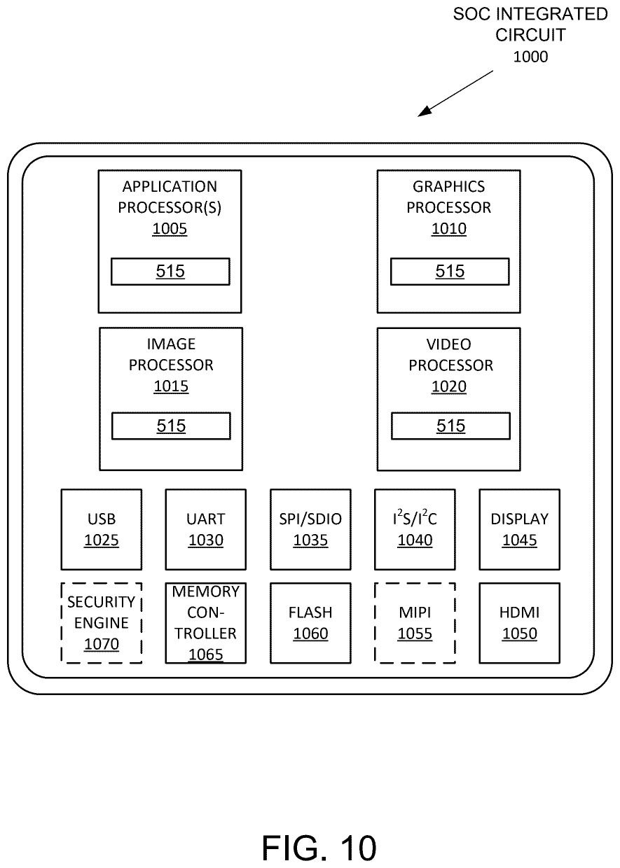

FIG. 10 illustrates exemplary integrated circuits and associated graphics processors that may be fabricated using one or more IP cores, according to various embodiments described herein. In addition to what is illustrated, other logic and circuits may be included in at least one embodiment, including additional graphics processors/cores, peripheral interface controllers, or general-purpose processor cores.

FIG. 10 is a block diagram illustrating an exemplary system-on-a-chip (SOC) integrated circuit 1000 that may be fabricated using one or more IP cores, according to at least one embodiment. In at least one embodiment, SOC integrated circuit 1000 includes one or more application processor(s) 1005 (e.g., CPUs), at least one graphics processor 1010, and may additionally include an image processor 1015 and/or a video processor 1020, any of which may be a modular IP core. In at least one embodiment, SOC integrated circuit 1000 includes peripheral or bus logic including a USB controller 1025, a UART controller 1030, an SPI/SDIO controller 1035, and an I²2S/I²2C controller 1040. In at least one embodiment, SOC integrated circuit 1000 can include a display device 1045 coupled to one or more of a high-definition multimedia interface (HDMI) controller 1050 and a mobile industry processor interface (MIPI) display interface 1055. In at least one embodiment, storage may be provided by a flash memory subsystem 1060 including flash memory and a flash memory controller. In at least one embodiment, a memory interface may be provided via a memory controller 1065 for access to SDRAM or SRAM memory devices. In at least one embodiment, some integrated circuits additionally include an embedded security engine 1070.

Inference and/or training logic 515 are used to perform inferencing and/or training operations associated with one or more embodiments. In at least one embodiment, inference and/or training logic 515 may be used in SOC integrated circuit 1000 for inferencing or predicting operations based, at least in part, on weight parameters calculated using neural network training operations, neural network functions and/or architectures, or neural network use cases described herein.

Embodiments presented herein can provide for the determination of whether to grant access to a user request using an authorization tree generated using classes of user-defined rules associated with a role assigned to a respective user.

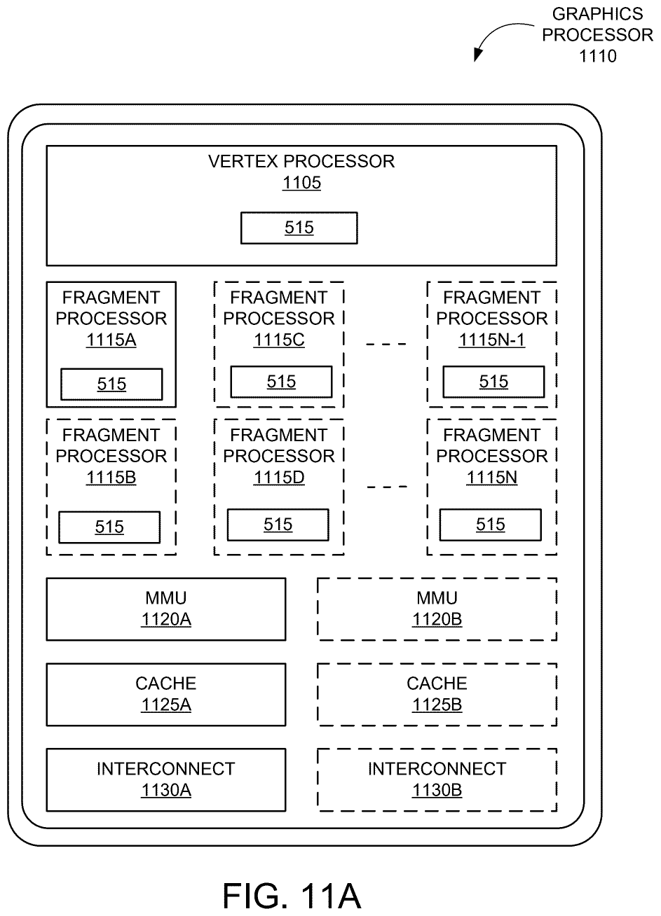

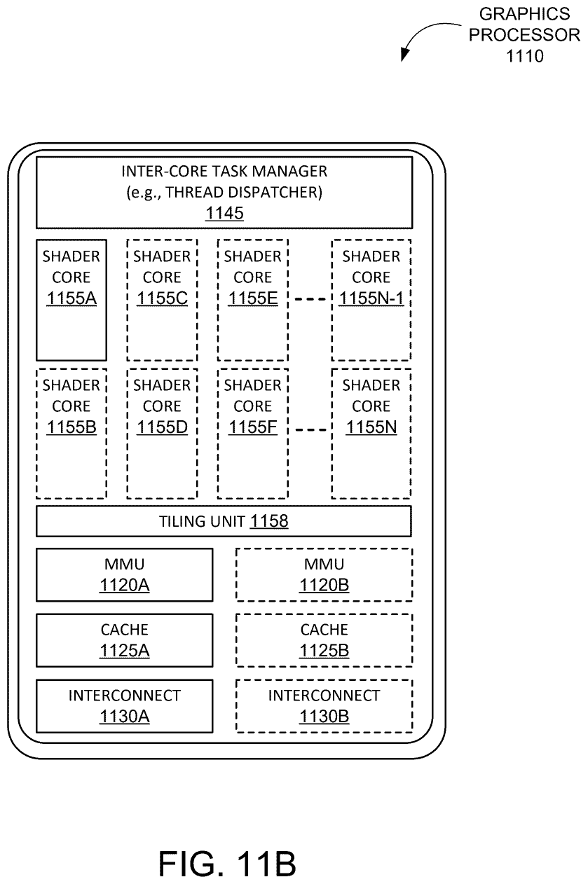

FIGS. 11A-11B illustrate exemplary integrated circuits and associated graphics processors that may be fabricated using one or more IP cores, according to various embodiments described herein. In addition to what is illustrated, other logic and circuits may be included in at least one embodiment, including additional graphics processors/cores, peripheral interface controllers, or general-purpose processor cores.

FIGS. 11A-11B are block diagrams illustrating exemplary graphics processors for use within an SoC, according to embodiments described herein. FIG. 11A illustrates an exemplary graphics processor 1110 of a system on a chip integrated circuit that may be fabricated using one or more IP cores, according to at least one embodiment. FIG. 11B illustrates an additional exemplary graphics processor 1140 of a system on a chip integrated circuit that may be fabricated using one or more IP cores, according to at least one embodiment. In at least one embodiment, graphics processor 1110 of FIG. 11A is a low power graphics processor core. In at least one embodiment, graphics processor 1140 of FIG. 11B is a higher performance graphics processor core. In at least one embodiment, each of graphics processors 1110, 1140 can be variants of computer system 900 of FIG. 9.

In at least one embodiment, graphics processor 1110 includes a vertex processor 1105 and one or more fragment processor(s) 1115A-1115N (e.g., 1115A, 1115B, 1115C, 1115D, through 1115N-1, and 1115N). In at least one embodiment, graphics processor 1110 can execute different shader programs via separate logic, such that vertex processor 1105 is optimized to execute operations for vertex shader programs, while one or more fragment processor(s) 1115A-1115N execute fragment (e.g., pixel) shading operations for fragment or pixel shader programs. In at least one embodiment, vertex processor 1105 performs a vertex processing stage of a 3D graphics pipeline and generates primitives and vertex data. In at least one embodiment, fragment processor(s) 1115A-1115N use primitive and vertex data generated by vertex processor 1105 to produce a framebuffer that is displayed on a display device. In at least one embodiment, fragment processor(s) 1115A-1115N are optimized to execute fragment shader programs as provided for in an OpenGL API, which may be used to perform similar operations as a pixel shader program as provided for in a Direct 3D API.

In at least one embodiment, graphics processor 1110 additionally includes one or more memory management units (MMUs) 1120A-1120B, cache(s) 1125A-1125B, and circuit interconnect(s) 1130A-1130B. In at least one embodiment, one or more MMU(s) 1120A-1120B provide for virtual to physical address mapping for graphics processor 1110, including for vertex processor 1105 and/or fragment processor(s) 1115A-1115N, which may reference vertex or image/texture data stored in memory, in addition to vertex or image/texture data stored in one or more cache(s) 1125A-1125B. In at least one embodiment, one or more MMU(s) 1120A-1120B may be synchronized with other MMUs within a system, including one or more MMUs associated with one or more application processor(s) 1105, image processors 1115, and/or video processors 1120 of FIG. 11A, such that each processor 1105-1120 can participate in a shared or unified virtual memory system. In at least one embodiment, one or more circuit interconnect(s) 1130A-1130B enable graphics processor 1110 to interface with other IP cores within SoC, either via an internal bus of SoC or via a direct connection.

In at least one embodiment, graphics processor 1140 includes one or more shader core(s) 1155A-1155N (e.g., 1155A, 1155B, 1155C, 1155D, 1155E, 1155F, through 1155N-1, and 1155N) as shown in FIG. 11B, which provides for a unified shader core architecture in which a single core or type or core can execute all types of programmable shader code, including shader program code to implement vertex shaders, fragment shaders, and/or compute shaders. In at least one embodiment, a number of shader cores can vary. In at least one embodiment, graphics processor 1140 includes an inter-core task manager 1145, which acts as a thread dispatcher to dispatch execution threads to one or more shader cores 1155A-1155N and a tiling unit 1158 to accelerate tiling operations for tile-based rendering, in which rendering operations for a scene are subdivided in image space, for example to exploit local spatial coherence within a scene or to optimize use of internal caches.

Embodiments presented herein can provide for the determination of whether to grant access to a user request using an authorization tree generated using classes of user-defined rules associated with a role assigned to a respective user.

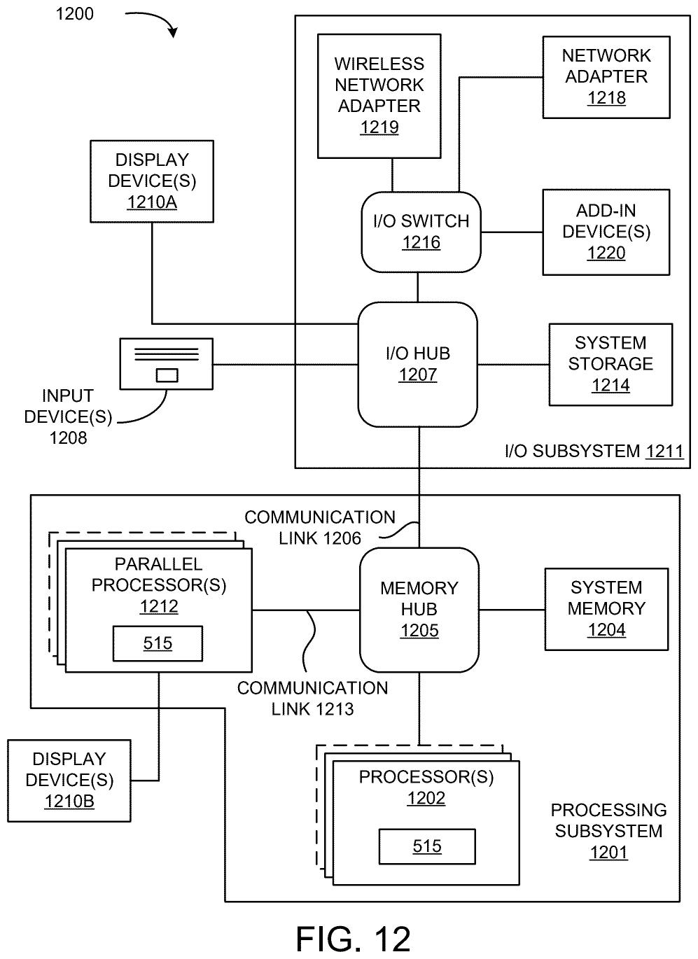

FIG. 12 is a block diagram illustrating a computing system 1200 according to at least one embodiment. In at least one embodiment, computing system 1200 includes a processing subsystem 1201 having one or more processor(s) 1202 and a system memory 1204 communicating via an interconnection path that may include a memory hub 1205. In at least one embodiment, memory hub 1205 may be a separate component within a chipset component or may be integrated within one or more processor(s) 1202. In at least one embodiment, memory hub 1205 couples with an I/O subsystem 1211 via a communication link 1206. In at least one embodiment, I/O subsystem 1211 includes an I/O hub 1207 that can enable computing system 1200 to receive input from one or more input device(s) 1208. In at least one embodiment, I/O hub 1207 can enable a display controller, which may be included in one or more processor(s) 1202, to provide outputs to one or more display device(s) 1210A. In at least one embodiment, one or more display device(s) 1210A coupled with I/O hub 1207 can include a local, internal, or embedded display device.

In at least one embodiment, processing subsystem 1201 includes one or more parallel processor(s) 1212 coupled to memory hub 1205 via a bus or other communication link 1213. In at least one embodiment, communication link 1213 may use one of any number of standards based communication link technologies or protocols, such as but not limited to PCI Express, or may be a vendor-specific communications interface or communications fabric. In at least one embodiment, one or more parallel processor(s) 1212 form a computationally focused parallel or vector processing system that can include a large number of processing cores and/or processing clusters, such as a many-integrated core (MIC) processor. In at least one embodiment, some or all of parallel processor(s) 1212 form a graphics processing subsystem that can output pixels to one of one or more display device(s) 1210A coupled via I/O hub 1207. In at least one embodiment, parallel processor(s) 1212 can also include a display controller and display interface (not shown) to enable a direct connection to one or more display device(s) 1210B. In at least one embodiment, parallel processor(s) 1212 include one or more cores, such as graphics cores 1200 discussed herein.

In at least one embodiment, a system storage unit 1214 can connect to I/O hub 1207 to provide a storage mechanism for computing system 1200. In at least one embodiment, an I/O switch 1216 can be used to provide an interface mechanism to enable connections between I/O hub 1207 and other components, such as a network adapter 1218 and/or a wireless network adapter 1219 that may be integrated into platform, and various other devices that can be added via one or more add-in device(s) 1220. In at least one embodiment, network adapter 1218 can be an Ethernet adapter or another wired network adapter. In at least one embodiment, wireless network adapter 1219 can include one or more of a Wi-Fi, Bluetooth, near field communication (NFC), or other network device that includes one or more wireless radios.

In at least one embodiment, computing system 1200 can include other components not explicitly shown, including USB or other port connections, optical storage drives, video capture devices, and like, may also be connected to I/O hub 1207. In at least one embodiment, communication paths interconnecting various components in FIG. 12 may be implemented using any suitable protocols, such as PCI (Peripheral Component Interconnect) based protocols (e.g., PCI-Express), or other bus or point-to-point communication interfaces and/or protocol(s), such as NV-Link high-speed interconnect, or interconnect protocols.

In at least one embodiment, parallel processor(s) 1212 incorporate circuitry optimized for graphics and video processing, including, for example, video output circuitry, and constitutes a graphics processing unit (GPU), e.g., parallel processor(s) 1212 includes graphics core 1200. In at least one embodiment, parallel processor(s) 1212 incorporate circuitry optimized for general purpose processing. In at least embodiment, components of computing system 1200 may be integrated with one or more other system elements on a single integrated circuit. For example, in at least one embodiment, parallel processor(s) 1212, memory hub 1205, processor(s) 1202, and I/O hub 1207 can be integrated into a system on chip (SoC) integrated circuit. In at least one embodiment, components of computing system 1200 can be integrated into a single package to form a system in package (SIP) configuration. In at least one embodiment, at least a portion of components of computing system 1200 can be integrated into a multi-chip module (MCM), which can be interconnected with other multi-chip modules into a modular computing system.

Inference and/or training logic 515 are used to perform inferencing and/or training operations associated with one or more embodiments. In at least one embodiment, inference and/or training logic 515 may be used in system FIG. 12 for inferencing or predicting operations based, at least in part, on weight parameters calculated using neural network training operations, neural network functions and/or architectures, or neural network use cases described herein.

Embodiments presented herein can provide for the determination of whether to grant access to a user request using an authorization tree generated using classes of user-defined rules associated with a role assigned to a respective user.

### Processors

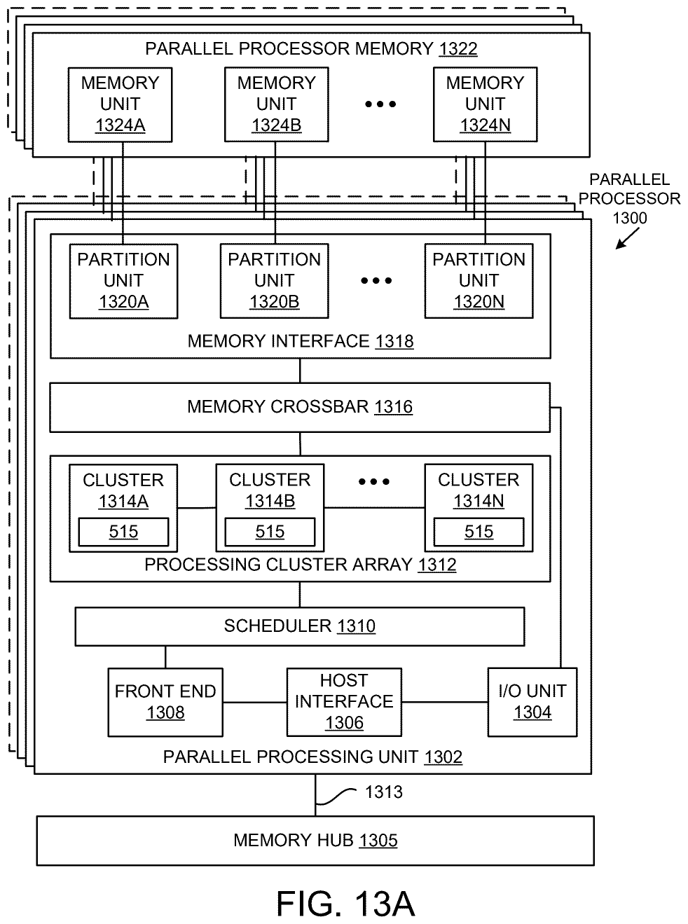

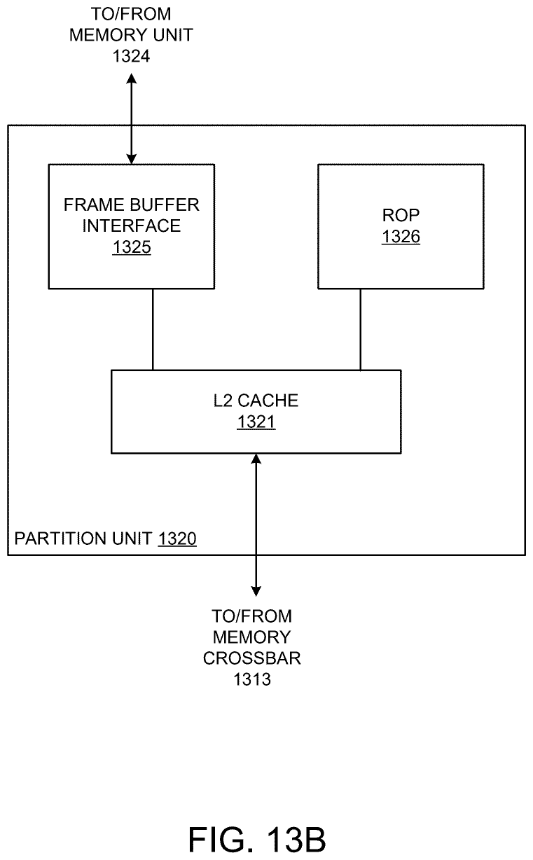

FIG. 13A illustrates a parallel processor 1300 according to at least one embodiment. In at least one embodiment, various components of parallel processor 1300 may be implemented using one or more integrated circuit devices, such as programmable processors, application specific integrated circuits (ASICs), or field programmable gate arrays (FPGA). In at least one embodiment, illustrated parallel processor 1300 is a variant of one or more parallel processor(s) 1212 shown in FIG. 12 according to an exemplary embodiment. In at least one embodiment, a parallel processor 1300 includes one or more graphics cores 1200.

In at least one embodiment, parallel processor 1300 includes a parallel processing unit 1302. In at least one embodiment, parallel processing unit 1302 includes an I/O unit 1304 that enables communication with other devices, including other instances of parallel processing unit 1302. In at least one embodiment, I/O unit 1304 may be directly connected to other devices. In at least one embodiment, I/O unit 1304 connects with other devices via use of a hub or switch interface, such as a memory hub 1305. In at least one embodiment, connections between memory hub 1305 and I/O unit 1304 form a communication link 1313. In at least one embodiment, I/O unit 1304 connects with a host interface 1306 and a memory crossbar 1313, where host interface 1306 receives commands directed to performing processing operations and memory crossbar 1316 receives commands directed to performing memory operations.

In at least one embodiment, when host interface 1306 receives a command buffer via I/O unit 1304, host interface 1306 can direct work operations to perform those commands to a front end 1308. In at least one embodiment, front end 1308 couples with a scheduler 1310 (which may be referred to as a sequencer), which is configured to distribute commands or other work items to a processing cluster array 1312. In at least one embodiment, scheduler 1310 ensures that processing cluster array 1312 is properly configured and in a valid state before tasks are distributed to a cluster of processing cluster array 1312. In at least one embodiment, scheduler 1310 is implemented via firmware logic executing on a microcontroller. In at least one embodiment, microcontroller implemented scheduler 1310 is configurable to perform complex scheduling and work distribution operations at coarse and fine granularity, enabling rapid preemption and context switching of threads executing on processing array 1312. In at least one embodiment, host software can prove workloads for scheduling on processing cluster array 1312 via one of multiple graphics processing paths. In at least one embodiment, workloads can then be automatically distributed across processing array cluster 1312 by scheduler 1310 logic within a microcontroller including scheduler 1310.

In at least one embodiment, processing cluster array 1312 can include up to “N” processing clusters (e.g., cluster 1314A, cluster 1314B, through cluster 1314N), where “N” represents a positive integer (which may be a different integer “N” than used in other figures). In at least one embodiment, each cluster 1314A-1314N of processing cluster array 1312 can execute a large number of concurrent threads. In at least one embodiment, scheduler 1310 can allocate work to clusters 1314A-1314N of processing cluster array 1312 using various scheduling and/or work distribution algorithms, which may vary depending on workload arising for each type of program or computation. In at least one embodiment, scheduling can be handled dynamically by scheduler 1310, or can be assisted in part by compiler logic during compilation of program logic configured for execution by processing cluster array 1312. In at least one embodiment, different clusters 1314A-1314N of processing cluster array 1312 can be allocated for processing different types of programs or for performing different types of computations.

In at least one embodiment, processing cluster array 1312 can be configured to perform various types of parallel processing operations. In at least one embodiment, processing cluster array 1312 is configured to perform general-purpose parallel compute operations. For example, in at least one embodiment, processing cluster array 1312 can include logic to execute processing tasks including filtering of video and/or audio data, performing modeling operations, including physics operations, and performing data transformations.

In at least one embodiment, processing cluster array 1312 is configured to perform parallel graphics processing operations. In at least one embodiment, processing cluster array 1312 can include additional logic to support execution of such graphics processing operations, including but not limited to, texture sampling logic to perform texture operations, as well as tessellation logic and other vertex processing logic. In at least one embodiment, processing cluster array 1312 can be configured to execute graphics processing related shader programs such as but not limited to, vertex shaders, tessellation shaders, geometry shaders, and pixel shaders. In at least one embodiment, parallel processing unit 1302 can transfer data from system memory via I/O unit 1304 for processing. In at least one embodiment, during processing, transferred data can be stored to on-chip memory (e.g., parallel processor memory 1322) during processing, then written back to system memory.

In at least one embodiment, when parallel processing unit 1302 is used to perform graphics processing, scheduler 1310 can be configured to divide a processing workload into approximately equal sized tasks, to better enable distribution of graphics processing operations to multiple clusters 1314A-1314N of processing cluster array 1312. In at least one embodiment, portions of processing cluster array 1312 can be configured to perform different types of processing. For example, in at least one embodiment, a first portion may be configured to perform vertex shading and topology generation, a second portion may be configured to perform tessellation and geometry shading, and a third portion may be configured to perform pixel shading or other screen space operations, to produce a rendered image for display. In at least one embodiment, intermediate data produced by one or more of clusters 1314A-1314N may be stored in buffers to allow intermediate data to be transmitted between clusters 1314A-1314N for further processing.

In at least one embodiment, processing cluster array 1312 can receive processing tasks to be executed via scheduler 1310, which receives commands defining processing tasks from front end 1308. In at least one embodiment, processing tasks can include indices of data to be processed, e.g., surface (patch) data, primitive data, vertex data, and/or pixel data, as well as state parameters and commands defining how data is to be processed (e.g., what program is to be executed). In at least one embodiment, scheduler 1310 may be configured to fetch indices corresponding to tasks or may receive indices from front end 1308. In at least one embodiment, front end 1308 can be configured to ensure processing cluster array 1312 is configured to a valid state before a workload specified by incoming command buffers (e.g., batch-buffers, push buffers, etc.) is initiated.

In at least one embodiment, each of one or more instances of parallel processing unit 1302 can couple with a parallel processor memory 1322. In at least one embodiment, parallel processor memory 1322 can be accessed via memory crossbar 1316, which can receive memory requests from processing cluster array 1312 as well as I/O unit 1304. In at least one embodiment, memory crossbar 1316 can access parallel processor memory 1322 via a memory interface 1318. In at least one embodiment, memory interface 1318 can include multiple partition units (e.g., partition unit 1320A, partition unit 1320B, through partition unit 1320N) that can each couple to a portion (e.g., memory unit) of parallel processor memory 1322. In at least one embodiment, a number of partition units 1320A-1320N is configured to be equal to a number of memory units, such that a first partition unit 1320A has a corresponding first memory unit 1324A, a second partition unit 1320B has a corresponding memory unit 1324B, and an N-th partition unit 1320N has a corresponding N-th memory unit 1324N. In at least one embodiment, a number of partition units 1320A-1320N may not be equal to a number of memory units.

In at least one embodiment, memory units 1324A-1324N can include various types of memory devices, including dynamic random access memory (DRAM) or graphics random access memory, such as synchronous graphics random access memory (SGRAM), including graphics double data rate (GDDR) memory. In at least one embodiment, memory units 1324A-1324N may also include 3D stacked memory, including but not limited to high bandwidth memory (HBM), HBM2c, or HDM3. In at least one embodiment, render targets, such as frame buffers or texture maps may be stored across memory units 1324A-1324N, allowing partition units 1320A-1320N to write portions of each render target in parallel to efficiently use available bandwidth of parallel processor memory 1322. In at least one embodiment, a local instance of parallel processor memory 1322 may be excluded in favor of a unified memory design that utilizes system memory in conjunction with local cache memory.

In at least one embodiment, any one of clusters 1314A-1314N of processing cluster array 1312 can process data that will be written to any of memory units 1324A-1324N within parallel processor memory 1322. In at least one embodiment, memory crossbar 1316 can be configured to transfer an output of each cluster 1314A-1314N to any partition unit 1320A-1320N or to another cluster 1314A-1314N, which can perform additional processing operations on an output. In at least one embodiment, each cluster 1314A-1314N can communicate with memory interface 1318 through memory crossbar 1316 to read from or write to various external memory devices. In at least one embodiment, memory crossbar 1316 has a connection to memory interface 1318 to communicate with I/O unit 1304, as well as a connection to a local instance of parallel processor memory 1322, enabling processing units within different processing clusters 1314A-1314N to communicate with system memory or other memory that is not local to parallel processing unit 1302. In at least one embodiment, memory crossbar 1316 can use virtual channels to separate traffic streams between clusters 1314A-1314N and partition units 1320A-1320N.

In at least one embodiment, multiple instances of parallel processing unit 1302 can be provided on a single add-in card, or multiple add-in cards can be interconnected. In at least one embodiment, different instances of parallel processing unit 1302 can be configured to interoperate even if different instances have different numbers of processing cores, different amounts of local parallel processor memory, and/or other configuration differences. For example, in at least one embodiment, some instances of parallel processing unit 1302 can include higher precision floating point units relative to other instances. In at least one embodiment, systems incorporating one or more instances of parallel processing unit 1302 or parallel processor 1300 can be implemented in a variety of configurations and form factors, including but not limited to desktop, laptop, or handheld personal computers, servers, workstations, game consoles, and/or embedded systems.

FIG. 13B is a block diagram of a partition unit 1320 according to at least one embodiment. In at least one embodiment, partition unit 1320 is an instance of one of partition units 1320A-1320N of FIG. 13A. In at least one embodiment, partition unit 1320 includes an L2 cache 1321, a frame buffer interface 1325, and a ROP 1326 (raster operations unit). In at least one embodiment, L2 cache 1321 is a read/write cache that is configured to perform load and store operations received from memory crossbar 1316 and ROP 1326. In at least one embodiment, read misses and urgent write-back requests are output by L2 cache 1321 to frame buffer interface 1325 for processing. In at least one embodiment, updates can also be sent to a frame buffer via frame buffer interface 1325 for processing. In at least one embodiment, frame buffer interface 1325 interfaces with one of memory units in parallel processor memory, such as memory units 1324A-1324N of FIG. 13A (e.g., within parallel processor memory 1322).

In at least one embodiment, ROP 1326 is a processing unit that performs raster operations such as stencil, z test, blending, etc. In at least one embodiment, ROP 1326 then outputs processed graphics data that is stored in graphics memory. In at least one embodiment, ROP 1326 includes compression logic to compress depth or color data that is written to memory and decompress depth or color data that is read from memory. In at least one embodiment, compression logic can be lossless compression logic that makes use of one or more of multiple compression algorithms. In at least one embodiment, a type of compression that is performed by ROP 1326 can vary based on statistical characteristics of data to be compressed. For example, in at least one embodiment, delta color compression is performed on depth and color data on a per-tile basis.

In at least one embodiment, ROP 1326 is included within each processing cluster (e.g., cluster 1314A-1314N of FIG. 13A) instead of within partition unit 1320. In at least one embodiment, read and write requests for pixel data are transmitted over memory crossbar 1316 instead of pixel fragment data. In at least one embodiment, processed graphics data may be displayed on a display device, such as one of one or more display device(s) 1510 of FIG. 15, routed for further processing by processor(s) 1302, or routed for further processing by one of processing entities within parallel processor 1300 of FIG. 13A.

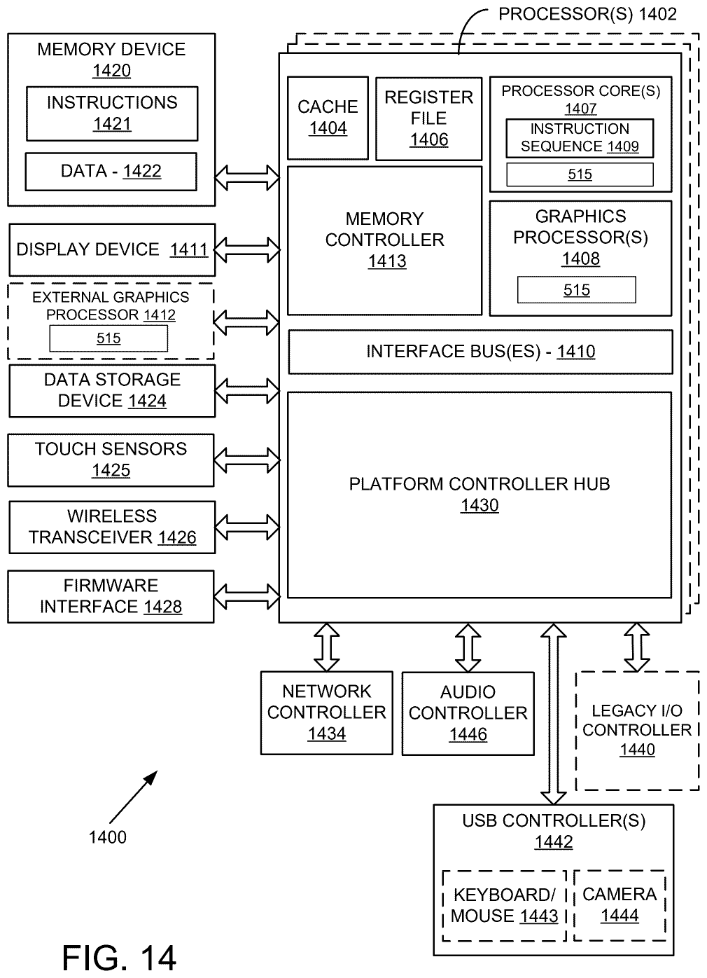

FIG. 14 is a block diagram of a processing system, according to at least one embodiment. In at least one embodiment, system 1400 includes one or more processor(s) 1402 and one or more graphics processor(s) 1408, and may be a single processor desktop system, a multiprocessor workstation system, or a server system having a large number of processor(s) 1402 or processor core(s) 1407. In at least one embodiment, system 1400 is a processing platform incorporated within a system-on-a-chip (SoC) integrated circuit for use in mobile, handheld, or embedded devices. In at least one embodiment, one or more graphics processor(s) 1408 include one or more graphics cores 1200.

In at least one embodiment, system 1400 can include, or be incorporated within a server-based gaming platform, a game console, including a game and media console, a mobile gaming console, a handheld game console, or an online game console. In at least one embodiment, system 1400 is a mobile phone, a smart phone, a tablet computing device or a mobile Internet device. In at least one embodiment, processing system 1400 can also include, couple with, or be integrated within a wearable device, such as a smart watch wearable device, a smart eyewear device, an augmented reality device, or a virtual reality device. In at least one embodiment, processing system 1400 is a television or set top box device having one or more processor(s) 1402 and a graphical interface generated by one or more graphics processor(s) 1408.

In at least one embodiment, one or more processor(s) 1402 each include one or more processor core(s) 1407 to process instructions which, when executed, perform operations for system and user software. In at least one embodiment, each of one or more processor core(s) 1407 is configured to process a specific instruction sequence 1409. In at least one embodiment, instruction sequence 1409 may facilitate Complex Instruction Set Computing (CISC), Reduced Instruction Set Computing (RISC), or computing via a Very Long Instruction Word (VLIW). In at least one embodiment, processor core(s) 1407 may each process a different instruction sequence 1409, which may include instructions to facilitate emulation of other instruction sequences. In at least one embodiment, processor core(s) 1407 may also include other processing devices, such a Digital Signal Processor (DSP).

In at least one embodiment, processor(s) 1402 includes a cache memory 1404. In at least one embodiment, processor(s) 1402 can have a single internal cache or multiple levels of internal cache. In at least one embodiment, cache memory is shared among various components of processor(s) 1402. In at least one embodiment, processor(s) 1402 also uses an external cache (e.g., a Level-3 (L3) cache or Last Level Cache (LLC)) (not shown), which may be shared among processor core(s) 1407 using known cache coherency techniques. In at least one embodiment, a register file 1406 is additionally included in processor(s) 1402, which may include different types of registers for storing different types of data (e.g., integer registers, floating point registers, status registers, and an instruction pointer register). In at least one embodiment, register file 1406 may include general-purpose registers or other registers.

In at least one embodiment, one or more processor(s) 1402 are coupled with one or more interface bus(es) 1410 to transmit communication signals such as address, data, or control signals between processor(s) 1402 and other components in system 1400. In at least one embodiment, interface bus(es) 1410 can be a processor bus, such as a version of a Direct Media Interface (DMI) bus. In at least one embodiment, interface bus(es) 1410 is not limited to a DMI bus, and may include one or more Peripheral Component Interconnect buses (e.g., PCI, PCI Express), memory busses, or other types of interface busses. In at least one embodiment processor(s) 1402 include an integrated memory controller 1416 and a platform controller hub 1430. In at least one embodiment, memory controller 1416 facilitates communication between a memory device and other components of system 1400, while platform controller hub (PCH) 1430 provides connections to I/O devices via a local I/O bus.

In at least one embodiment, a memory device 1420 can be a dynamic random access memory (DRAM) device, a static random access memory (SRAM) device, flash memory device, phase-change memory device, or some other memory device having suitable performance to serve as process memory. In at least one embodiment, memory device 1420 can operate as system memory for system 1400, to store data 1422 and instructions 1421 for use when one or more processor(s) 1402 executes an application or process. In at least one embodiment, memory controller 1416 also couples with an optional external graphics processor 1412, which may communicate with one or more graphics processor(s) 1408 in processor(s) 1402 to perform graphics and media operations. In at least one embodiment, a display device 1411 can connect to processor(s) 1402. In at least one embodiment, display device 1411 can include one or more of an internal display device, as in a mobile electronic device or a laptop device, or an external display device attached via a display interface (e.g., DisplayPort, etc.). In at least one embodiment, display device 1411 can include a head mounted display (HMD) such as a stereoscopic display device for use in virtual reality (VR) applications or augmented reality (AR) applications.

In at least one embodiment, platform controller hub 1430 enables peripherals to connect to memory device 1420 and processor(s) 1402 via a high-speed I/O bus. In at least one embodiment, I/O peripherals include, but are not limited to, an audio controller 1446, a network controller 1434, a firmware interface 1428, a wireless transceiver 1426, touch sensors 1425, a data storage device 1424 (e.g., hard disk drive, flash memory, etc.). In at least one embodiment, data storage device 1424 can connect via a storage interface (e.g., SATA) or via a peripheral bus, such as a Peripheral Component Interconnect bus (e.g., PCI, PCI Express). In at least one embodiment, touch sensors 1425 can include touch screen sensors, pressure sensors, or fingerprint sensors. In at least one embodiment, wireless transceiver 1426 can be a Wi-Fi transceiver, a Bluetooth transceiver, or a mobile network transceiver such as a 3G, 4G, or Long Term Evolution (LTE) transceiver. In at least one embodiment, firmware interface 1428 enables communication with system firmware, and can be, for example, a unified extensible firmware interface (UEFI). In at least one embodiment, network controller 1434 can enable a network connection to a wired network. In at least one embodiment, a high-performance network controller (not shown) couples with interface bus(es) 1410. In at least one embodiment, audio controller 1446 is a multi-channel high definition audio controller. In at least one embodiment, system 1400 includes an optional legacy I/O controller 1440 for coupling legacy (e.g., Personal System 2 (PS/2)) devices to system 1400. In at least one embodiment, platform controller hub 1430 can also connect to one or more Universal Serial Bus (USB) controller(s) 1442 connect input devices, such as keyboard and mouse 1443 combinations, a camera 1444, or other USB input devices.

In at least one embodiment, an instance of memory controller 1416 and platform controller hub 1430 may be integrated into a discreet external graphics processor, such as external graphics processor 1412. In at least one embodiment, platform controller hub 1430 and/or memory controller 1416 may be external to one or more processor(s) 1402. For example, in at least one embodiment, system 1400 can include an external memory controller 1416 and platform controller hub 1430, which may be configured as a memory controller hub and peripheral controller hub within a system chipset that is in communication with processor(s) 1402.

Embodiments presented herein can provide for the determination of whether to grant access to a user request using an authorization tree generated using classes of user-defined rules associated with a role assigned to a respective user.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A processor, comprising:
one or more logical units to:
receive, on behalf of a user, a request for access to at least one resource;
extract, from one or more portions of the request including a request payload, a set of request data;
compare the set of request data against an authorization tree, the authorization tree specifying one or more classes of rules associated with the user; and
determine whether to grant, on behalf of the user, access to the resource based at least in part on an action specified in the authorization tree and corresponding to the set of request data.

2. The processor of claim 1, wherein the authorization tree includes a hierarchy of nodes at different levels, the levels including a set of classes of rules at a first level aggregated to a set of roles at a second level, the set of roles aggregated to a set of users at a third level higher than the first and second levels.

3. The processor of claim 1, wherein the action is associated with a path of the request, and wherein individual rules are associated with respective paths and permissions.

4. The processor of claim 1, wherein the request is a restful API request.

5. The processor of claim 1, wherein the set of request data is further extracted from at least one of a header, an endpoint, an address, or a protocol method of the request.

6. The processor of claim 1, wherein multiple rules of the authorization tree are determined to apply to the request and are to be used to determine the action.

7. The processor of claim 1, wherein the one or more logical units are further to generate a request tree and a response tree, and determine whether to grant access further based upon comparing the request tree and the response tree against the authorization tree.

8. The processor of claim 1, wherein child nodes of the authorization tree automatically inherit permissions of a parent node unless otherwise specified.

9. The processor of claim 1, wherein the one or more logical units are further to attempt to authenticate and authorize the request before extracting the set of request data.

10. A system, comprising:
one or more processors to:
extract, from at least a header and a payload of a request received on behalf of a user, a set of request data specifying an endpoint corresponding to an action to be performed;
determine, using the set of request data, an actual endpoint corresponding to the action is to be performed;
determine, from an authorization tree associated with the user, a permission and an action corresponding to the actual endpoint; and
determine whether to grant access to the request based in part on the permission and the action corresponding to the actual endpoint.

11. The system of claim 10, wherein the one or more processors are further to:
generate a request tree using the set of request data; and
compare nodes of the request tree against corresponding nodes of the authorization tree to determine the permission and the action corresponding to the actual endpoint.

12. The system of claim 10, wherein the one or more processors are further to:
generate a response tree using the set of request data; and
compare nodes of the response tree against corresponding nodes of the authorization tree to determine which data to include in a response generated for the request.

13. The system of claim 10, wherein the authorization tree includes a hierarchy of nodes at different levels, the levels including a set of rules at a first level aggregated to a set of classes at a second level, the set of classes aggregated to a set of roles at a third level higher than the first and second levels.

14. The system of claim 10, wherein the action is associated with one or more rules of a class, and wherein individual rules are associated with respective paths and permissions.

15. The system of claim 10, wherein the one or more processors are to extract the set of request data further from at least one of a header, an endpoint, an address, or a protocol method of the request.

16. The system of claim 10, wherein the system is at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or
a system implemented at least partially using cloud computing resources.

17. A computer-implemented method, comprising:
extracting, from at least a header and a payload of a request received on behalf of a user, a set of request data specifying an endpoint corresponding to an action to be performed;
determining, using the set of request data, an actual endpoint corresponding to the action is to be performed;
determining, from an authorization tree associated with the user, a permission and an action corresponding to the actual endpoint; and
determining whether to grant access to the request based in part on the permission and the action corresponding to the actual endpoint.

18. The computer-implemented method of claim 17, further comprising:
generating a request tree using the set of request data; and
comparing nodes of the request tree against corresponding nodes of the authorization tree to determine the permission and the action corresponding to the actual endpoint.

19. The computer-implemented method of claim 17, further comprising:
generating a response tree using the set of request data; and
comparing nodes of the response tree against corresponding nodes of the authorization tree to determine which data to include in a response generated for the request

20. The computer-implemented method of claim 17, wherein the authorization tree includes a hierarchy of nodes at different levels, the levels including a set of rules at a first level aggregated to a set of classes at a second level, the set of classes aggregated to a set of roles at a third level higher than the first and second levels.
